(19) United States
(12) Patent Application Publication
(10) Pub. No.: US 2002/0055872 A1
(43) Pub. Date: May 9, 2002

(54) User services and information management system and method

(76) Inventors: David William LaBrie, Wauwatosa, WI (US); Anthony Lawrence Preman, Milwaukee, WI (US)

Correspondence Address: Alistair K. Chan, FOLEY & LARDNER, Firstar Center, 777 East Wisconsin Avenue, Milwaukee, WI, 53202-5367, US

(21) Appl. No.: 09/887,509

(22) Filed: Jun. 22, 2001

Related U.S. Application Data
(60) Provisional application No. 60/213,462, filed on Jun. 23, 2000.

(51) Int. Cl. G06F 17/60; G06F 15/16

(52) U.S. Cl. 705/14; 709/219

(57) ABSTRACT

A user services and information management system and method is disclosed. In particular, the user services and information management system may be applied to a passenger information system for a cruise ship. The passenger information system may include a communications network, a server coupled to the communications network, and a terminal device including a processor and a display. The terminal device is in communications with the communications network and is configured to access information from the server. The passenger information system also includes a user interface provided on the display of the terminal device. The user interface includes the user selectable options and is configured to selectively provide passenger information to a cruise ship passenger.

### REFERENCE TO RELATED APPLICATIONS

This application claims the benefit of U.S. provisional patent application No. 60/213,462, filed on Jun. 23, 2000, the entirety of which is herein incorporated by reference.

### FIELD OF THE INVENTION

The present application relates to a system and method for administrating and providing services and information management for a user who is a visitor, guest, or passenger at a site such as a resort, ski resort, amusement park, cruise ship, hotel, hospital, airport, educational or corporate campus or any other specific site. The system and method include but are not limited to a network providing or interconnecting various services, subsystems, access points, data structures, accounts, processes and other methods of administration and information management.

### BACKGROUND OF THE INVENTION

Annually, millions of people visit and use sites such as resorts, ski resorts, amusement parks, cruise ships, hotel, hospital, airport, educational or corporate campus, etc. They seek to enjoy many of the services available at these sites, and their surrounding areas, in an orderly and efficient manner. Normally, site users may spend substantial time traveling within a specific site to enjoy all or most of the activities or services provided at the site, such as a roller coaster ride, a theater performance, a restaurant meal, etc. However, site users may be unable to fully utilize or enjoy a site's activities and services because the site user may spend substantial time trying to find, follow, and read maps that are difficult to understand or maps that may not provide them with the best route to follow within a specific site, and such that the site user may enjoy most or all of the activities chosen at a moments notice. Further, site users may not be able to fully utilize the activities and services offered at a specific site because they may have to spend substantial time trying to find each other after being separated or plan on meeting times and places. Further still, site users may not be able to enjoy the activities of a specific site because site users may not interact on a “real time basis” with activities providers or with other site users within the specific site. Conventional information systems are not tailored to provide location-based services that can meet the specific and ever changing needs of site users at a moments notice.

Consequently, there is a need for a system that provides location-based services by allowing site users to access information regarding a particular activity and/or service provider, e.g., ride, restaurant, shop, etc., within a site or within its surrounding area from any location within the site visited. There is also a need for a system that provides location-based services by allowing site users to interact with the service provider, e.g., to learn about the site user's account balance; to learn about wait times for restaurants and rides; to get directions to a service provider; to make reservations; to purchase tickets; to purchase goods; etc., from any location within the site visited. There is also a need for a system that provides location-based services by allowing visitors to access this information from pre-designated terminal locations and from anywhere within a site through wireless devices.

There is also a need for a location-based services solution that makes it easier for organizations to extend their data and brands to mobile devices, without the risk and expensive development of a custom application. There is a need for location based-services that enable companies to capitalize on an array of business opportunities made possible by mobile devices, such as but not limited to: publishing location-based content to travelers and urban residents; driving foot traffic to stores using location-based advertisements and promotions; obtaining quantitative research on aggregate traffic and product usage patterns; and tracking inventory within multi-point distribution channels.

Further, there is a need for location-based services that enable publishers to extend their brands and content to mobile users by: driving revenue through subscriptions, targeted mobile advertising, enhanced listing and transactions; acquiring customers for print and online properties; and establishing an economical, efficient channel for user-generated content.

Further still, there is a need for location-based services that enable directory publishers to parlay their brands and advertising relationships into the wireless arena by: giving consumers access to directories from wherever they are, whenever they want; upsell current advertisers with an effective mobile marketing solution; and helping users to find their way to businesses by providing highly-readable vector maps, walking and driving directions, and public transportation information.

Yet further still, there is a need for location-based services that provide site users with a value-added service—and a reason for repeat business, such as by offering travelers a powerful tool for planning their activities on the go, based on location or destination; creating new services uniquely possible on mobile devices, such as the ability for travelers to communicate and exchange opinions and travel tips based on their current location; and offering restricted access to fee-based “premium content.”

It would be desirable to provide a system and/or method that provides one or more of these or other advantageous features. Other features and advantages will be made apparent from the present specification. The teachings disclosed extend to those embodiments which fall within the scope of the appended claims, regardless of whether they accomplish one or more of the aforementioned needs.

### SUMMARY OF THE INVENTION

An exemplary embodiment of the invention relates to a passenger information system for a cruise ship. The passenger information system includes a cruise ship communications network and a server coupled to the communications network. The passenger information system also includes a terminal device including a processor and a display. The terminal device is in communication with communications network and is configured to access information from the server. The passenger information system also includes a user interface provided on the display of the terminal device. The user interface includes user selectable options and is configured to selectively provide passenger information to a cruise ship passenger.

Another exemplary embodiment of the invention relates to as user information system for a ski resort. The user information system includes a communication network and a server coupled to the communications network. The user information system also includes a terminal device including a processor and a display. The terminal device is in communication with the communications network and is configured to access information from the server. The user information system also includes a user interface provided on the display of the terminal device. The user interface includes user selectable options and is configured to selectively provide user information to a ski resort user.

Another exemplary embodiment of the invention relates to a user information system for an amusement park. The user information system includes a communications network and a server coupled to the communications network. The user information system also includes a terminal device including a processor and a display. The terminal device is in communication with the communications network and is configured to access information from the server. The user information system further includes a user interface provided on the display of the terminal device. The user interface includes visitor selectable options and is configured to selectively provide visitor to an amusement park visitor.

Another exemplary embodiment of the invention relates to a user information system for a resort. The user information system includes a communications network and a server coupled to the communications network. The user information system also includes a terminal device including a processor and a display. The terminal device is in communication with the communications network and is configured to access information from the server. The user information system also includes a user interface provided on the display of the terminal device. The user interface includes user selectable options and is configured to selectively provide user information to a resort user.

Another exemplary embodiment of the invention relates to a passenger information system for a cruise ship. The passenger information system includes a cruise ship communications network, an off-ship communications network, at least one radio frequency transceiver, a server, and a terminal device configured to communicate with each other. The terminal device includes kiosks and handheld computers. The kiosks include a processor and a display, and the handheld computers include a radio frequency transceiver. The display presents the passenger with selectable options which provide the passenger with information about the cruise ship and certain off-ship destinations. The selectable options include a navigator system, an explorer system, an activities system, a cruise ship reservation system, an off-ship excursion system, a passenger messaging system, a cruise ship data system, a port of call data system, an account information system, a muster information system, and an advertising system.

Another exemplary embodiment of the invention relates to a method of providing site specific information to a user of a site. The method includes providing a site user with a portable electronic device including wireless communications electronics. The method also includes accessing by the user a user interface with a plurality of user selectable information service options. The method also includes selecting an information service option. Further, the method includes communicating the selection from the portable electronic device to a site specific communications network and receiving a response to the selection by the portable electronic device from the site specific communications network.

Another exemplary embodiment of the invention relates to a user information system for a ski resort where the user information system includes a communications network, at least one RF transceiver, a server, and a terminal device configured to communicate with each other. The terminal device includes kiosks and handheld computers. The kiosks include a processor and a display, and the handheld computers include a radio frequency transceiver. The display presents the ski resort user with selectable options which provide the user with information about the ski resort. The selectable options include a navigator system, an explorer system, an activities system, a ski resort reservation system, an excursion system, a ski resort user messaging system, a ski resort data system, an account information system, an emergency information system, and an advertising system.

Another exemplary embodiment of the invention relates to a user information system for an amusement park where the user information system includes a communications network, at least one RF transceiver, a server, and a terminal device configured to communicate with each other. The terminal device includes kiosks and handheld computers. The kiosks include a processor and a display, and the handheld computers include a radio frequency transceiver. The display presents the amusement park visitor with selectable options which provide the visitor with information about the amusement park and certain destinations out of the park. The selectable options include a navigator system, an explorer system, an activities system, an amusement park reservation system, an out of park excursion system, a visitor messaging system, an account information system, an emergency services information system, and an advertising system.

Another exemplary embodiment of the invention relates to a user information system for a resort where the user information system includes a communications network, at least one RF transceiver, a server, and a terminal device configured to communicate with each other. The terminal device includes kiosks and handheld computers. The kiosks include a processor and a display, and the handheld computers include a radio frequency transceiver. The display presents the resort user with selectable options which provide the user with information about the resort. The selectable options include a navigator system, an explorer system, an activities system, a resort reservation system, an excursion system, a resort user messaging system, a resort data system, an account information system, an emergency information system, and an advertising system.

Alternative exemplary embodiments relate to other features and combinations of features as may be generally recited in the claims.

### DESCRIPTION OF FIGURES

The invention will become more fully understood from the following detailed description, taken in conjunction with the accompanying drawings, wherein like reference numerals refer to like elements.

FIG. 1 is a block diagram showing an exemplary embodiment of a passenger information system for a cruise ship.

FIG. 2 is a block diagram showing an exemplary embodiment of a user information system for a ski resort.

FIG. 3 is a block diagram showing an exemplary embodiment of a user information system for an amusement park.

FIG. 4 is a block diagram showing an exemplary embodiment of a user information system for a resort.

FIG. 5 is a block diagram showing an exemplary embodiment of a hybrid network within a resort, ski resort, amusement park, cruise ship, hotel, hospital, airport, educational or corporate campus, etc.

FIG. 6 is a block diagram showing an exemplary embodiment of an intelligent interactive profiling system.

FIG. 7 is a block diagram showing an exemplary embodiment of a main menu of an interactive information system for a cruise ship.

FIG. 8 is a block diagram showing an exemplary embodiment of a main menu of an interactive database system, for a cruise ship.

FIG. 9 is a block diagram showing an exemplary embodiment of a navigator system menu for a cruise ship.

FIG. 10 is a block diagram showing another exemplary embodiment of a navigator system menu for a cruise ship.

FIG. 11 is a block diagram showing an exemplary embodiment of a daily activities system interface for a cruise ship.

FIG. 12 is a block diagram showing an exemplary embodiment of an in-house dining reservation system for a cruise ship.

FIG. 13 is a block diagram showing another exemplary embodiment of an in-house dining reservation system for a cruise ship.

FIG. 14 is a block diagram showing an exemplary embodiment of a shore excursion information ticketing system for a cruise ship.

FIG. 15 is a block diagram showing another exemplary embodiment of a shore excursion information ticketing system interface for a cruise ship.

FIG. 16 is a block diagram showing another exemplary embodiment of a shore excursion information ticketing system interface for a cruise ship.

FIG. 17 is a block diagram showing an exemplary embodiment of a messaging system for a cruise ship.

FIG. 18 is a block diagram showing another exemplary embodiment of a messaging system for a cruise ship.

FIG. 19 is a block diagram showing an exemplary embodiment of a cruise ship information/data system interface.

FIG. 20 is a block diagram showing an exemplary embodiment of a port of call explorer system for a cruise ship.

FIG. 21 is a block diagram showing another exemplary embodiment of a port of call explorer system for a cruise ship.

FIG. 22 is a block diagram showing an exemplary embodiment of a ship account inquiry system for a cruise ship.

FIG. 23 is a block diagram showing another exemplary embodiment of a ship account inquiry system interface for a cruise ship.

FIG. 24 is a block diagram showing an exemplary embodiment for a process of a main menu hierarchy of a cruise ship information system.

FIG. 25 is a block diagram showing an exemplary embodiment for a process of exchanging information between a navigator module and a passenger of a cruise ship.

FIG. 26 is a block diagram showing an exemplary embodiment for a process for exchanging information between an onboard reservation module and a passenger of a cruise ship.

FIG. 27 is a block diagram of exemplary embodiments of physical wireless web architectures.

### DETAILED DESCRIPTION OF PREFERRED AND EXEMPLARY EMBODIMENTS

According to a particularly preferred embodiment, the system and method provides interactive network based application programs (subsystems) delivered to access points at a site such as a resort or cruise ship to a user interface (e.g. a computing device, stationary or mobile, having a display with touch screen technology). The combination of subsystems can be modified and the features provided by the subsystems can be both “scaled” and customized to suit the purposes of management or a system administrator of a particular site (e.g. individualized or personalize for specific users).

According to any preferred embodiment, the system and method is intended to simplify the way users (e.g. guests or passengers) interact with the suppliers of their “vacation experience” (e.g. at a resort or on a cruise ship). The system and method is intended to offer potential cost savings, increased profit opportunities, and the enhancement of the overall passenger (user or visitor) experience by offering the convenience of access points in close proximity to where users spend the majority of their time, the “common areas” of the site (e.g. resort or cruise ship) or alternatively by using mobile electronic devices with wireless networking technologies provided to visitors to the site or brought to the site by the user. The system and method is intended to replace and/or augment existing personal and/or current in-room/in-cabin (on-site) processes by a network (e.g. internet) based technology, adding new functionality while also allowing the integration of various existing functions into a single customizable system. The system and method is intended to facilitate the overall experience of the user by, among other things, reducing the delays, long lines, miscommunications, missed opportunities and redundant business practices that may inconvenience a user (such as a vacationer).

According to a particularly preferred embodiment, the system and method may be administered by a host who maintains a network connection with the site and related enterprises, as well as with users and potential users, that will allow the collection, processing and sharing of data and information.

### Definition of Terms

User: A user may be a visitor to a site, such as a passenger on a cruise ship, a guest at a resort, or any other person who may use or require services or information at or in connection with a visit to a site. A user may be a vacationer or visitor or other person who has visited the site or who intends to visit the site.

Site: A site may be a resort, ski resort, amusement park, cruise ship, hotel, hospital, airport, educational or corporate campus or other location, facility, or the like.

Network: A network may include any type of interconnection between two or more access points. A network has include all conventional networking arrangements for computing devices (e.g. local area network, intranet, internet [World Wide Web], etc.) including any of wired, optical, and wireless networking technologies.

Access Point: An access point is any device providing a user interface at or through a network (e.g. between one computing device and another). An access point may typically be a computing device (such as a personal computer, personal digital assistant (PDA), terminal, etc.). A kiosk may be associated with the access point providing some type of user interface for access to some or all of the features of the system. An access point may be located on the site or elsewhere (e.g. a personal computer at the residence of a user through the internet).

Access Device: An access device is any type of device (such as an access card having a magnetic strip) that in combination with another device (such as a reader through which the access card is “swiped”) allows the identity of a user (i.e. person in possession of the access device) or other user information to be determined. The access device may be used to restrict access to the system or to provide a level of security for information and data. The access device may contain or work in conjunction with entry of a PIN, user name, and/or a password by the user.

Personal Identification Number (PIN): A PIN is a numeric code used by a user to gain access to information or privileges through the system. The PIN may be the room number of the user where the site is a resort, hotel, cruise ship or the like. The PIN may be used to restrict access to the system by unauthorized users or to provide a level of security for information and data.

Profile: A profile is a collection of information known about a user. The profile may include information collected during transactions or interactions by the user during the present visit to the site, during prior visits to any site, off-site and/or voluntarily provided by the user. The “privileges” or level of access or user interface presented to a user may be adapted or modified based on the information (such as demographics) contained in the profile of the user.

User Interface: A user interface will be capable of providing information in text/graphical and/or audio-visual (i.e. audio and/or visual) form. According to a typical arrangement, the user interface will allow interaction between the user and one or more subsystems, for example through a touch screen display. According to other arrangements, the user interface may have a separate keyboard or other input device, or may be provided by any of a wide variety of computing devices. Additionally, an interactive television device within a specific site, such as a cruise ship, cabin, or hotel room may serve as an additional user interface, and may allow user-subsystem interaction through the use of conventional and/or unconventional interactive television controls. In an addition exemplary embodiment, the user interface may include an option to receive requested information in an audio format and further receive the audio in a language of the user's choice. Such audio broadcast may be in an MPEG3 (MP3) or other applicable formats.

Enterprise: An enterprise is a vendor, service provider, retail outlet, business, or entity that may be located on-site or off-site. An enterprise may transact commercial business, augment existing business or provide activities for one or more users.

### OVERVIEW

According to any preferred or exemplary embodiment, the system and method is intended to provide for any one or more of a set of services and/or information management in connection with a visit by a user to a site.

### SYSTEM DESCRIPTION AND EXEMPLARY FUNCTIONALITY

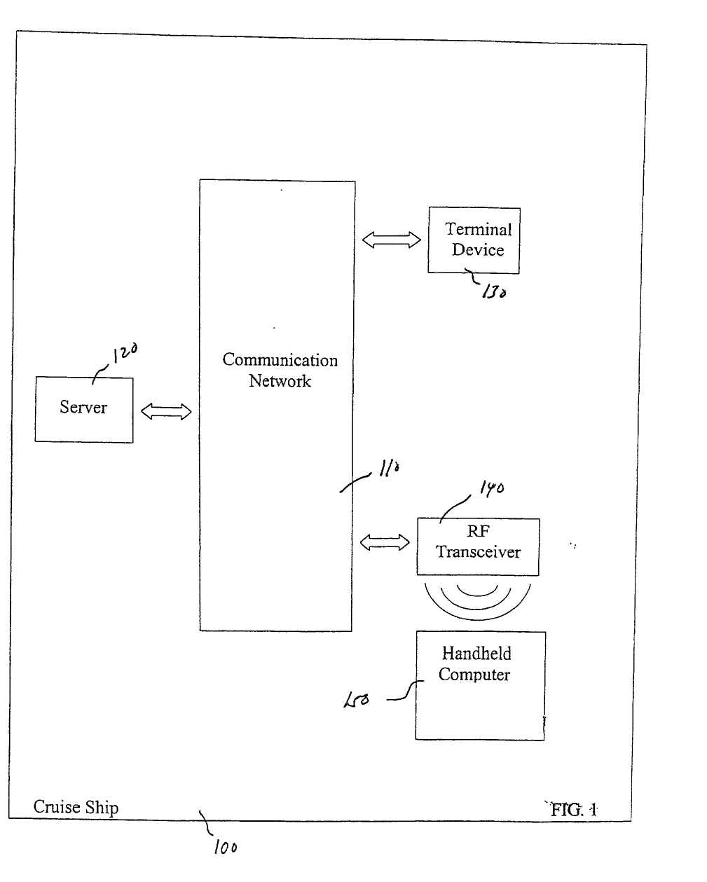

The system and method according to an exemplary embodiment is configured for implementation in a site shown as a cruise ship 100 (FIG. 1). It is important to note that according to alternative embodiments (FIGS. 1-4), the system and method can be implemented in any other site or type of site (including combinations of sites).

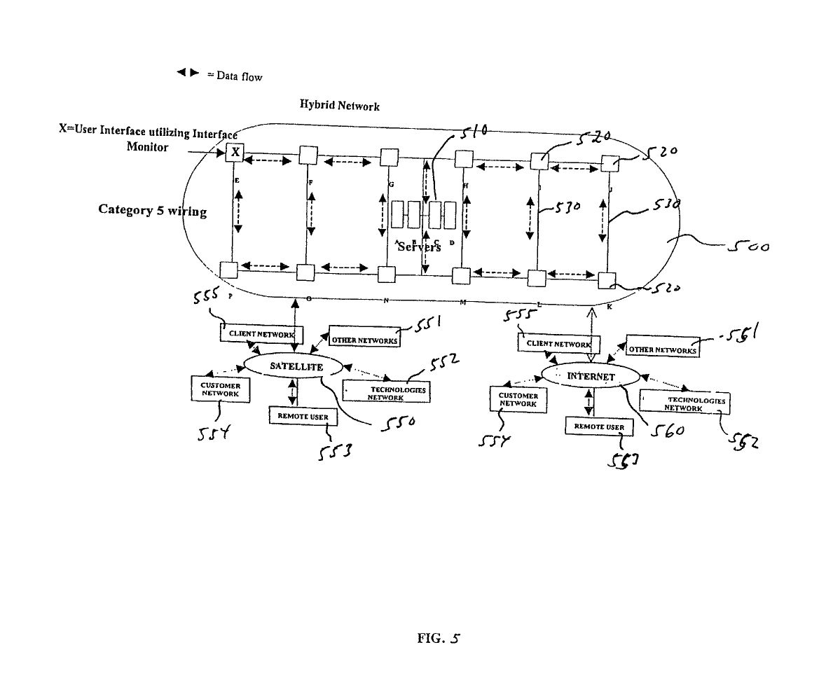

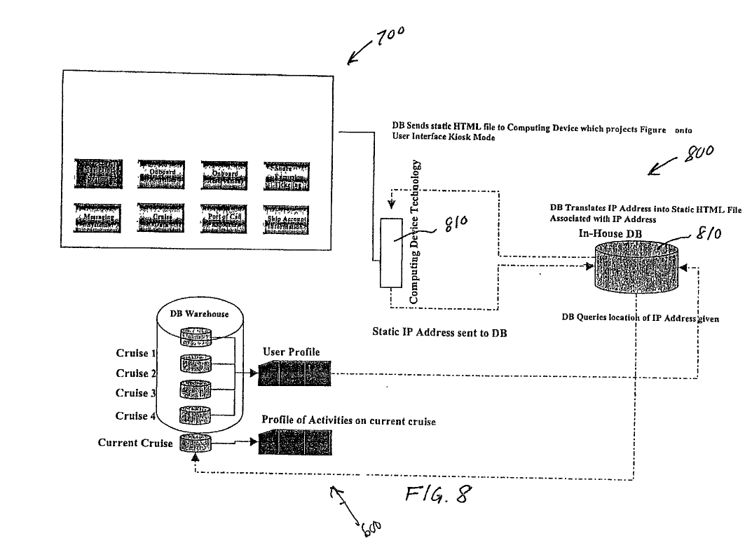

The system and method includes a number of functional subsystems (or applications, see FIG. 8 for example), any one or more of which can be combined according to various embodiments. The subsystems may be made accessible to users at one or more user interfaces associated with access points, including access points on the site or available through a network (such as the internet, see FIG. 5, for example). Additional functionality and interrelation of the subsystems (including the steps that may be performed) according to preferred and other exemplary embodiments is shown in the FIGURES.

It should be noted that users who seek to use the system and method at an access point may be required to present an access device of some kind to allow the identification of the user or alternatively to identify themselves as an authorized user by using, e.g., a predetermined user name and password combination, or other identification method. Certain users may be entitled to “privileges” or enhanced system access in comparison to other users. An access point may include an interface to “read” an access device. A printer may be associated with one or more of the access points.

According to a particularly preferred embodiment, the system and method may include a “default” or “attract” mode, in which the user interface at a particular access point may present information intended to demonstrate the functionality of the system (as configured for the site), or may present a customizable informational message of some type. The user interface may be configured to enter the “default” or “attract” mode after a pre-determined period of time without a user interaction.

The system and method can be configured so that a user may have access to one or more subsystems before a visit to the site or after a visit to the site, through a network connection (e.g. the internet). For example, according to a particularly preferred embodiment, from off-site (e.g. at home), a user who is considering whether to schedule a visit to the site (e.g. a vacation on a cruise ship) may use the system to obtain information about the site; a user who has scheduled a visit to the site may learn more about the site (and various activities, dining, excursions, etc. in connection with the site).

Navigator System: The Navigator subsystem is intended to assist a user with finding various destinations within the site.

According to a particularly preferred embodiment (FIGS. 8-10 and 25), the site is a cruise ship, and the Navigator system provides a user with the ability to identify various destinations on the cruise ship and provides instructions in the form of directions from one destination (e.g. an access point providing a user interface such as at a kiosk) to another destination. The Navigator system may include a three-dimensional (3D) graphical model of the site and present a display of the graphical model at the user interface. Through the user interface, the user at a present location (i.e. the location of the access point presenting the user interface) will then select a destination (e.g. arranged from a listing or index by type, category, general location, name or the like). The Navigator system will then provide text directions to the selected destination and/or a 3D animation illustrating a preferred path of travel from the present location to the selected destination. (According to an alternative embodiment, the animation may be provided in a two dimensional graphical model.)

According to a particularly preferred embodiment, the Navigator system will incorporate CAD drawings/files of the site integrated into a networked application (e.g. Macromedia Shockwave Flash, Active-X or the like) that is touch-screen operated. Using the Navigator system, a user may approach any one of several conveniently-placed access points (e.g. kiosk) and through the user interface obtain directions to any destination on the site.

According to a particularly preferred embodiment, the Navigator system may include an interface with a Global Positioning System (GPS) that will provide the user real time positioning and tracking information about a passenger's exact location within a cruise ship or within a particular site. Using the Navigator system, a passenger may receive a location signal instantaneously from a GPS satellite, from any location within the cruise ship, through a portable electronic device such as a handheld computer, PDA, or similar device equipped with a GPS receiver. The Navigator system may also provide text descriptions and/or 2D or 3D animations of the passenger's exact location within a cruise ship. The Navigator system may also provide an audio broadcast, in MP3 or other applicable formats, of direction information in a passenger's native language or other selected languages.

Through the user interface, additional information and/or options may be presented to the user. For example, an advertising bar may be displayed giving information to the user that relates to one or more of the available destinations; specific information about or relating to a selected destination (such as a coupon redeemable at the destination) may be made available to the user. The content of the advertising bar or on a coupon may be customized or personalized based on information contained in the user profile or other available data.

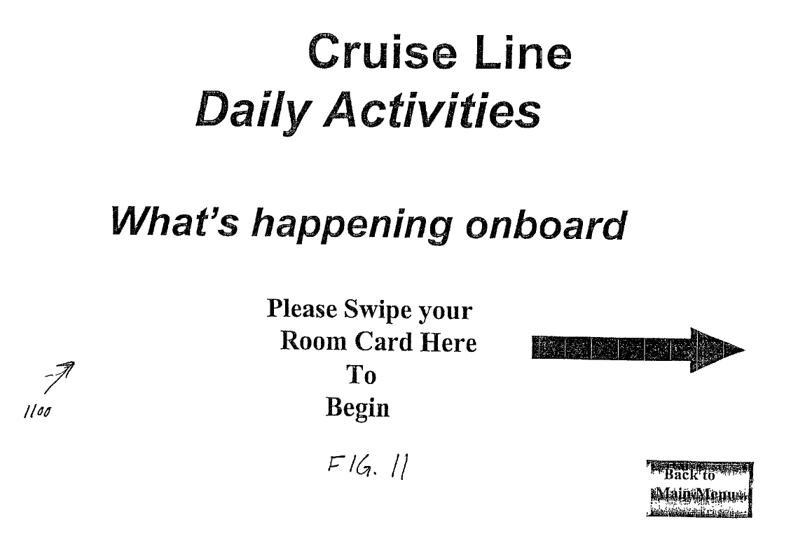

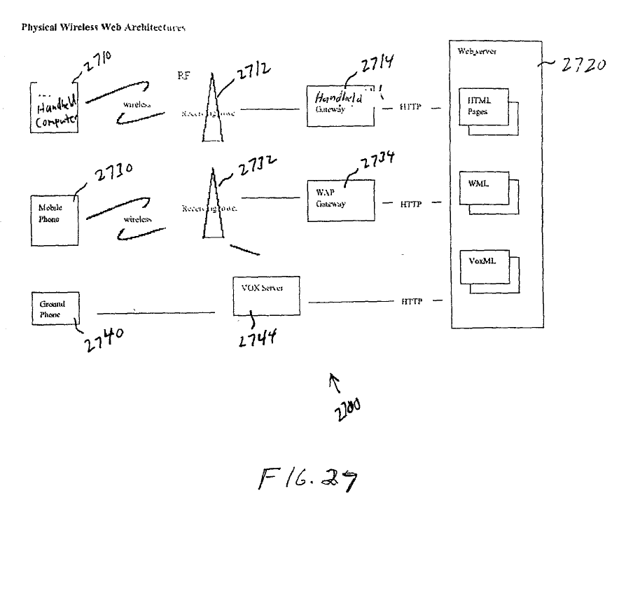

Daily Activities System: The Daily Activities subsystem is intended to provide information to a user as to activities and events planned, scheduled or otherwise taking place at the site. According to a particularly preferred embodiment (FIGS. 11, 27), the site is a cruise ship and the activities are various activities taking place onboard the cruise ship.

The activities may be listed by date and available for review and display at the user interface in advance. By selecting a particular activity, additional information (if any) relating to the activity may be presented to the user.

According to a particularly preferred embodiment, the user interface at a kiosk may be configured to have a “default” mode of operation in which information regarding daily activities is presented according to a predetermined sequence, i.e. freely available for viewing by a user without the need for any further interaction.

The Daily Activities subsystem also may be customized for affiliated groups of users or personalized for a particular user based on the profile of the user (e.g. whether a child or adult or member of a particular group, such as a group tour). The subsystem may also use information as to the preferences, level of skill or experience, or interests, etc., of a user from the user profile to modify the user interface to present a personalized activities list or planner. Two or more users may be “linked” to share an activity.

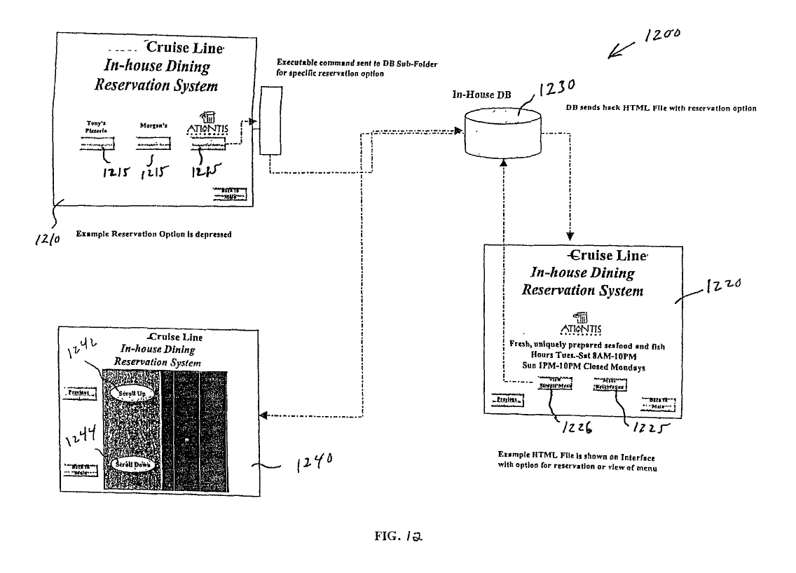

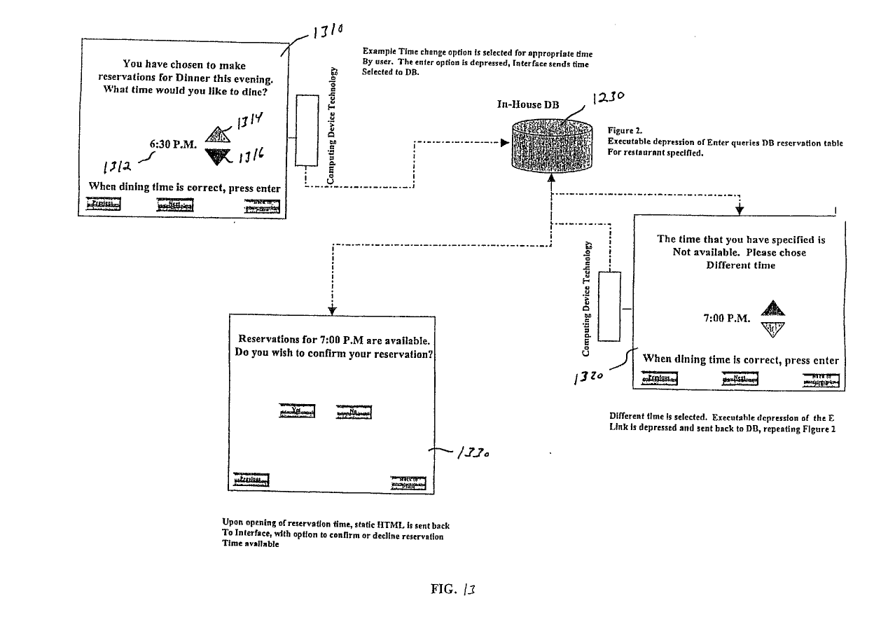

On-Site Reservation (Activities and Dining) System: The On-Site Reservation subsystem is intended to allow users to identify and make reservations to participate in various activities, transportation and dining available on the site, or to review dining choices and make a reservation for dining at one or more restaurants on the site. According to a particularly preferred embodiment (FIG. 12-13, 26), the site is a cruise ship, or the activities are scheduled activities on the ship and the restaurants are those restaurants located on the ship.

Using the subsystem, the user is able to select the activity from a list of choices (which may be arranged or indexed according to subject matter or by other categories). Upon selecting the activity, the user is then able to choose a particular date and time for a particular number of participants—if the selected date and time is available (as indicated by data records). According to any preferred embodiment, the subsystem will be linked to the enterprise conducting the activity or to the restaurant by a network so that all relevant information may be transmitted; according to alternative embodiments, the subsystem will transmit the relevant information in some form for recordation and acknowledgment.

The subsystem may also allow a user to select a restaurant from the list of available choices, obtain an informational message regarding the restaurant (e.g. hours of service and cuisine), view a sample menu and make a reservation at a particular date and time for a particular number of guests—if the selected date and time is available (as indicated by data records).

According to any preferred embodiment, the user will be able to make a “self-service” reservation, using account information (as through an access device). Upon choosing an activity/dining and time, the system then queries the database to ensure that the time is available and if it is, then reserves that time for the user upon verification. If necessary, the On-Site Reservation subsystem may print out a “ticket” or notice with the name of the user and the date and time of the reservation; according to a particularly preferred embodiment, the ticket may be printed in a format that is computer-readable for convenience.

The On-Site Reservation subsystem is intended to reduce administration costs and increase user satisfaction.

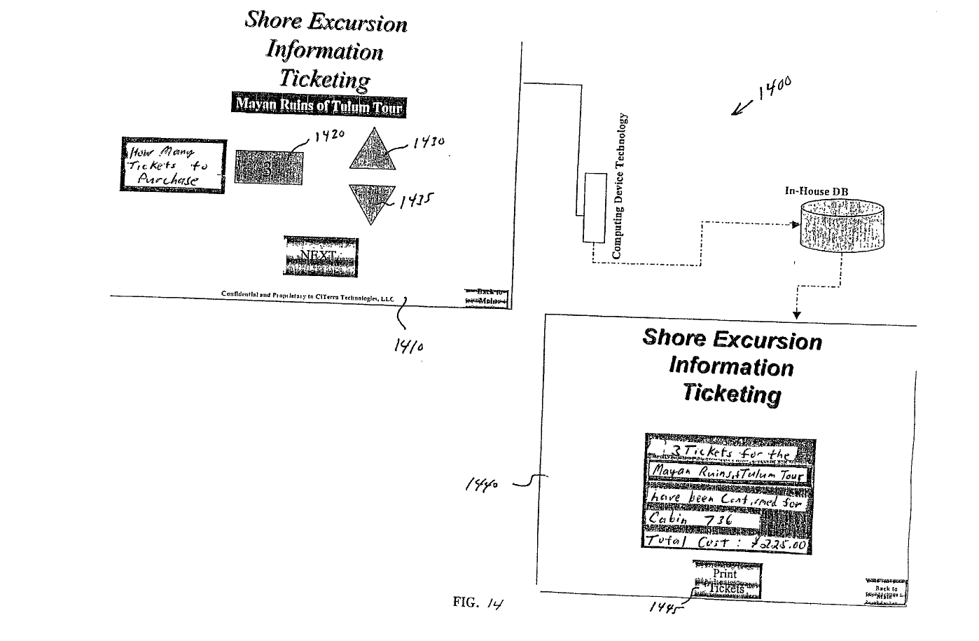

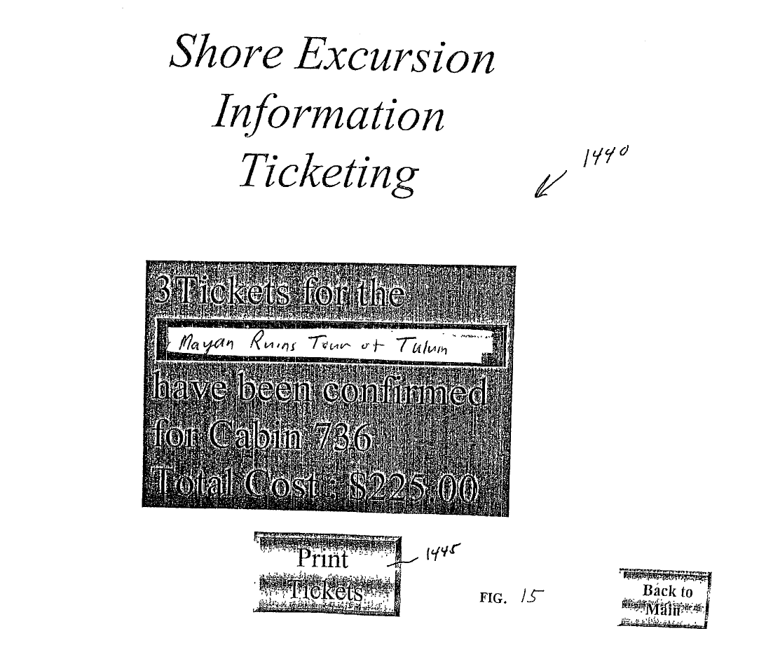

Off-Site Excursion Information and Ticketing System: The Excursion Information subsystem is intended to provide a user with information regarding excursions off the site to one or more destinations. According to a particularly preferred embodiment (FIGS. 14-16, 28), the Excursion Information subsystem is implemented on a site shown as a cruise ship to allow passengers to schedule excursions to attractions (such as tours, museums, sites of interests, etc.) at various destinations at various ports of call of the cruise.

The Excursion Information subsystem can be adapted to a particular site, to give reference to attractions that are accessible at each port of call. Each port may have one or more attractions, which will be listed and linked to an informational message in the form of a text and/or audio-visual display of pertinent information relating to the attraction. The subsystem may provide the user the option of obtaining tickets and/or of placing a reservation (if necessary) for a visit to the attraction. (Tickets may be ordered for subsequent pick-up by the user or printed by a printer at any authorized access point.)

According to any preferred embodiment, the destination will be “registered” with the Excursion Information subsystem to ensure that the information provided at the user interface is accurate and up to date (and possibly to allow revenue generation from commercial enterprises or vendors associated with a destination). According to an alternative embodiment where the destination has an internet website, the user interface may allow the user to visit the website to review any additional information that is available.

According to any preferred embodiment, the system allows “self service” reservations and ticketing without the user having to wait in line (i.e. for long amounts of time) at the destination or upon arrival at the port of call in order to reserve a place on an excursion or for other activities within or outside of the ship; when the user arrives at the port of call, ticketing has already been completed. This subsystem may be integrated with the existing on-site reservation system to allow real-time reservations and instantaneous ticketing to passengers at any hour of the day or any day of the week.

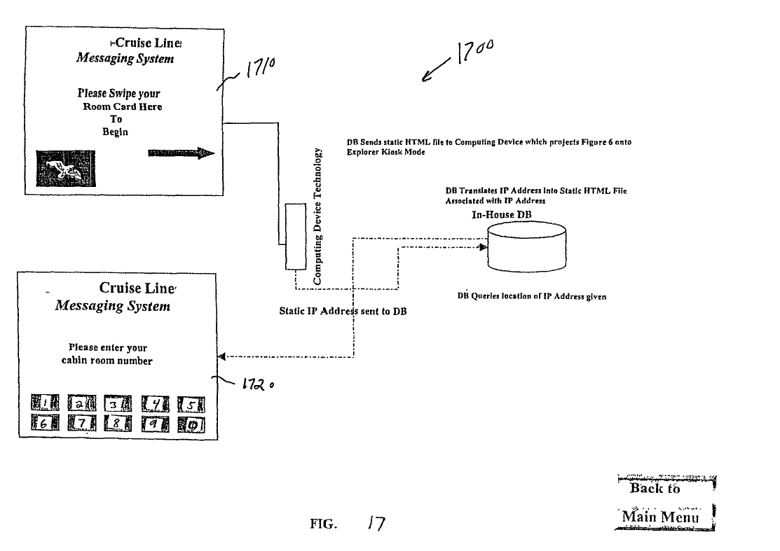

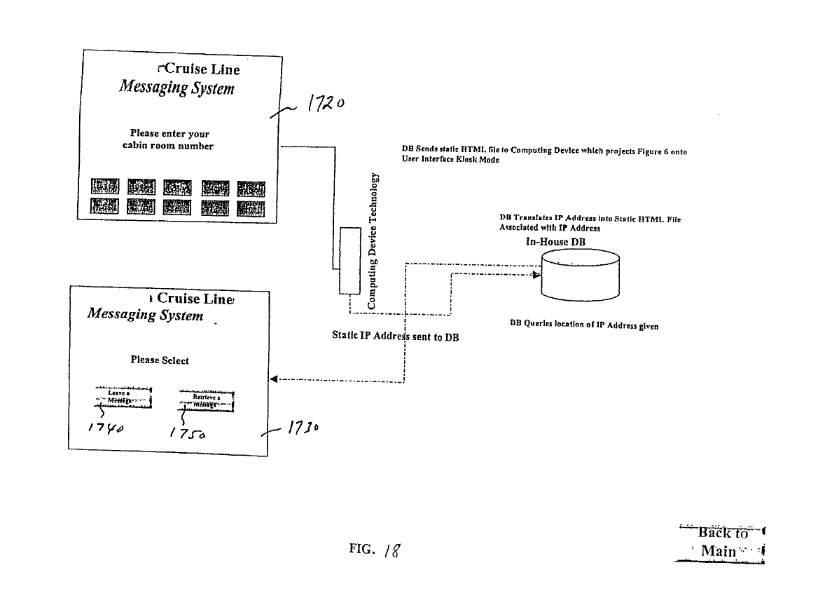

Messaging System: The Messaging subsystem is intended to allow communications between users within the site (and possibly others off-site). According to a particularly preferred embodiment (FIGS. 17-18), the site is a cruise ship.

The Messaging subsystem will allow one user to transmit a message to another user through a user interface.

The Messaging subsystem also allows a user to send or retrieve messages at the user interface. Messages can be retrieved by user name and/or room number; messages can be composed on a keyboard (e.g. as part of a touch screen display). According to any preferred embodiment, messaging services can be provided through conventional messaging systems (on-site and off-site); internet e-mail send/receive capabilities may also be provided through the subsystem (including e-mail forwarding).

According to any preferred embodiment, couples or groups intending to attend different activities and events that are occurring on different areas of the ship or resort may remain in contact (without the need for paging which is typically now restricted to emergencies). The Messaging subsystem may also be configured to prevent miscommunication that may occur between users intending to meet; one user may indicate at a user interface in a message the area of the ship or resort where the user will be for an interval of time; another user may then, after identifying the other user (e.g. by name or room number), check for and obtain the message.

The Messaging subsystem will also allow messages to be “broadcast” to all users by a system administrator. The Messaging subsystem will further provide assistance to children who may have become lost or otherwise separated from a supervising adult or guardian. When a “children's assistance” message is sent from the user interface, a message is transmitted to security personnel on the site that a child needing assistance may be waiting at the user interface (i.e. kiosk); the user interface will display a message (i.e. cartoon video) asking the child to wait next to the user interface until assistance arrives.

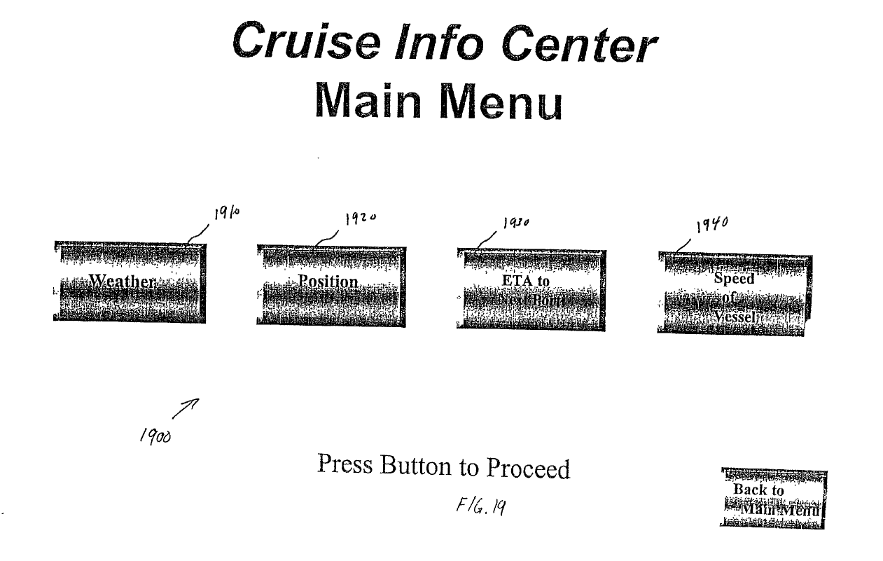

Cruise Information/Data System: The Information subsystem is intended to provide a user with information about the site (such as the operation of the site). According to a particularly preferred embodiment (FIGS. 19, 30), the site is a cruise ship.

The Information Center subsystem is accessible through the user interface and will provide information of interest to a user, such as the weather forecast, location/position of the ship, estimated time of arrival (ETA) at the next port, speed of travel of the ship, etc. According to any preferred embodiment, the subsystem will make information pertinent to the site available for the interest and/or entertainment of one or more users. The information may be displayed in text and/or audio-visual format.

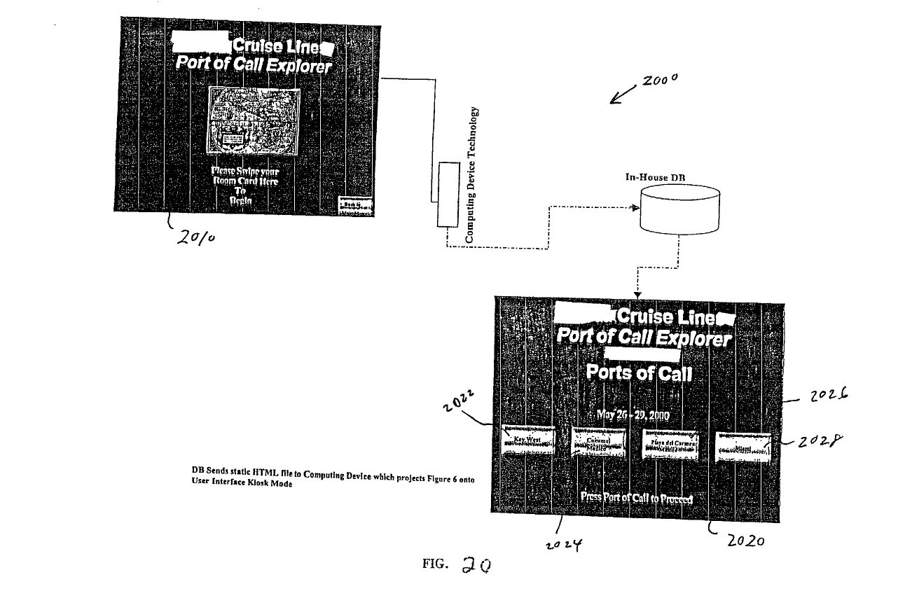

Explorer System: The Explorer subsystem is intended to assist a user in the planning of activities off-site to one or more destinations. According to a particularly preferred embodiment (FIGS. 20-21, 29), the Explorer subsystem (also referred to specifically as a “Port of Call Explorer” subsystem) is implemented on a site shown as a cruise ship to allow passengers to identify and plan activities at destinations at various ports of call of the cruise. The Explorer subsystem may include an interface with a Global Positioning System (GPS) that will provide a passenger real time information to identify and plan activities at various destinations from any location within the cruise ship (within the site) or off the cruise ship (outside of the site). Using the Explorer subsystem, a user may receive a location signal instantaneously from a GPS satellite, from any location through a portable user interface such as a handheld computer, PDA, or similar device equipped with a GPS receiver. The Explorer subsystem may also provide an audio broadcast, in MP3 or other applicable formats, of this and other relevant information in a passenger's native language or other selected languages.

The Explorer subsystem can be adapted to a particular site, to give reference to destinations that are accessible at each port of call. Each port may have a “briefing” in the form of a text and/or audio-visual display of pertinent information of general interest. In addition, each port may have associated categories of destinations, such as sights (or sites) of interest, restaurants, shopping, nightlife, other commercial enterprises, etc. A “currency exchange” informational message may be provided (along with one or more associated advertising displays) for convenience of the user. Specific categories of destinations may be listed within a more general category; each destination may have a particular informational message in text and/or audio-visual format. The destination may also be listed with additional descriptive information (such as the type of cuisine served at a particular restaurant, or even with a display of the menu and pricing). The subsystem may provide the user with directions to a particular destination (e.g. by various modes of travel, such as walking, taxi, bus or other alternatives) as well as the option of obtaining tickets and/or of placing a reservation (if necessary) for a visit to the destination.

According to any preferred embodiment, the destination will be “registered” with the Explorer subsystem to ensure that the information provided at the user interface is accurate and up to date (and possibly to allow revenue generation from commercial enterprises associated with a destination). According to an alternative embodiment where a commercial enterprise or other enterprise associated with the destination has an internet website, the user interface may allow the user to visit the website directly to review any additional information that is made available.

According to any preferred embodiment, a user will be given information about the destination without having to consult or rely on pamphlets or brochures (or other people) as to where to tour or dine, transportation options, currency exchange, and what activities to attend, etc. while in this off-site destination (e.g. port).

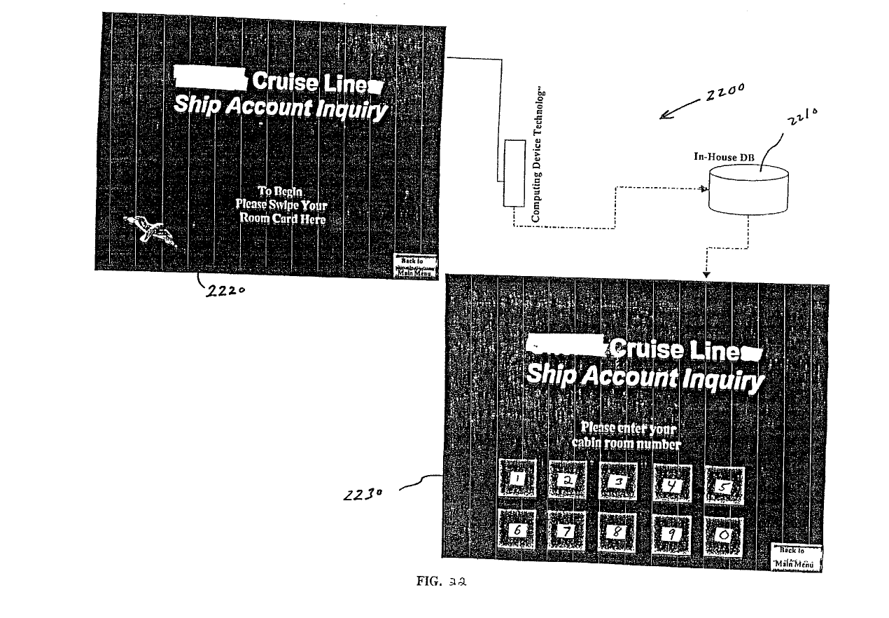

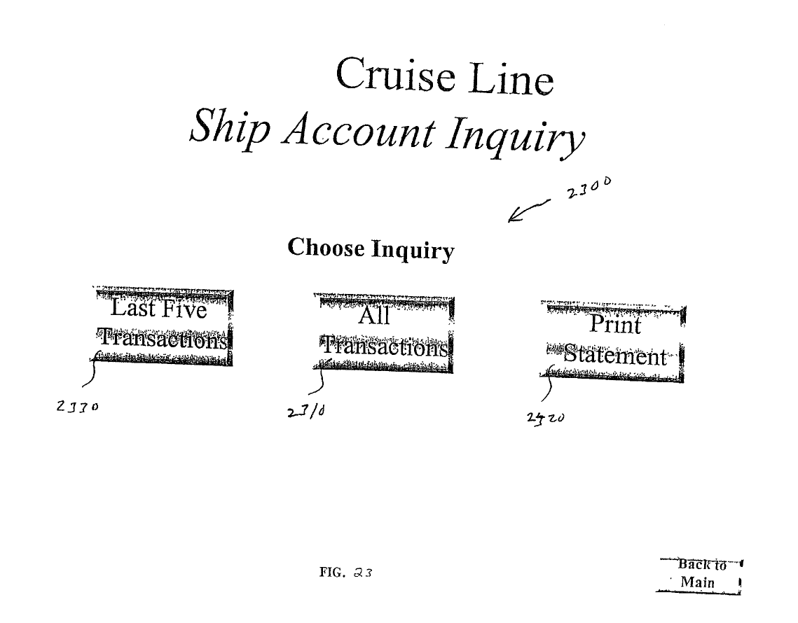

Account Inquiry System: The Account Inquiry subsystem is intended to allow a user to access and view charges, credits and other transactions and information pertaining to the user's account at the site. According to a particularly preferred embodiment (FIG. 22-23), the site is a cruise ship.

At a user interface, the user is provided the opportunity to make an inquiry related to the user's account. The subsystem may be configured to be accessible to a user at any time, on-site or off-site, before, during or after the visit to the site.

Advertising/Couponing System: The Advertising/Couponing subsystem can be operated in conjunction with any one or more of the other subsystems and/or separately. The subsystem allows the display of advertisements (e.g. in text/graphical and/or audio-visual format) associated with one or more vendors or commercial enterprises on the user interface. The subsystem also allows the creation (e.g. for printing at an authorized printer) of coupons (e.g. which may relate to a commercial enterprise) for the user to apply in connection with a visit to the site. According to a particularly preferred embodiment, the couponing subsystem will provide an enterprise affiliated with the site to inform of and/or share with a user a discount or special promotion. Vendors or commercial enterprises (e.g. retail tenants) at a site may be asked to pay for the opportunity to have their products or services promoted via this subsystem.

### SYSTEM IMPLEMENTATION AND EXEMPLARY EMBODIMENTS

According to any preferred embodiment, the system and method may be implemented using a combination of known and conventional computing devices (hardware and/or systems) and operating systems and programming languages, using software modified and adapted to perform the functions of the various subsystems. According to a particularly preferred embodiment, the system and method may be implemented in Microsoft Windows NT with application programs and related code written in a Java-based programming language. According to alternative embodiments, any suitable operating system and/or programming language may be used to implement the functions of the various subsystems.

The system and method allows the linking and display of information available from a various internal and/or other databases, or over a network (such as an intranet or the internet). Information may be presented at a user interface as text, as a graphical display, or in audio-visual form (i.e. audio and/or visual content).

According to a particularly preferred embodiment, the network servers are IBM Netfinity 5600 (Model No. 8664-2RY) and the access points and user interfaces are provided through a computing device such as a Wyse Winterm 3350SE (which may be referred to as a “thin client”) with an NEC MultiSync LCD 2010T providing MicroTouch capacitive touch (screen) technology. According to alternative embodiments, any of a variety of other computing devices and servers may be used to implement the system and method.

The system and method (e.g. the subsystems/application programs) is customizable for a particular site, for a particular group of users, for a particular season, or even for a particular user.

Physical Environment/Installation: The system and method can be installed in any type of site. According to an exemplary embodiment where the site is a cruise ship (FIG. 5), the access points can be installed at any of a wide variety of locations throughout the cruise ship (e.g. including but not limited to the locations as shown with reference character X).

According to alternative embodiments, the system and method can be installed in various facilities such as a resort, ski resort, amusement park, cruise ship, hotel, hospital, airport, educational or corporate campus, or the like.

Networking: According to a preferred embodiment (FIG. 5), the system and method will be implemented over a hybrid network including access to a client network, customer network, proprietary network, and allowing communications over the internet and/or satellite communications to remote users; the site will include one or more network servers and/or one or more access points providing a user interface. Further, the network may use any of a variety of devices including wireless enabled devices for communicating with the communications network. Further still, the network may use any of a variety of standard or nonstandard communications protocols, such as but not limited to transfer control protocol/internet protocol (TCP/IP), IEEE 802.11 protocol, etc.

According to a particularly preferred embodiment (FIG. 5), the “Technologies Network” 552 is representative of a host network (e.g. administered by the host of the system) from which the application programs and other related information can be modified and/or transmitted to access points or other parts of the overall network. The “Client Network” 555 is representative of the network operated by the management of the site (e.g. the company operating a resort or cruise ship); a “customer network” 554 is a network through which a user may access the system from off-site (e.g. over the internet); a “remote user” network 553 is any connection that may be established to friends, acquaintances, relatives, etc.; and “other networks” 551 are any other networks to other persons or entities (e.g. to travel agents who may seek information from the site). Network communications can be established over any feasible link, such as wiring (e.g. Category 5 cable), telephony, the internet, satellite communications (FIG. 27) radio frequency (RF) communications, and the like. (The system and method may be configured to provide full functionality to users at any access point.)

The host of the system and/or the management of the site may individually or collaboratively control or modify the content of the system and/or the information and subsystems presented or accessible at each access point and user interface.

### Data Structures and Content

The system and method and each of the subsystems both use existing data and collect and modify existing data. The data may be stored for later analysis and used in the creation and maintenance of user profiles.

According to any preferred embodiment, the data may include (but will not be limited to) some or all of the following subject matter:

1. Information relating to the site, including destinations and commercial enterprises and operating and scheduling information for events and activities.

2. User information including demographics (e.g., age, gender, income, etc.), personal information (e.g. health limitations; dietary restrictions, activities), preferences, hobbies, interests and experience, affiliations, and other information.

3. Usage patterns for user (e.g. activities performed on-site, off-site or in some combination; transactions; interactions with the system).

The data may be used to refine a user profile and/or to personalize (individualize) or customize the form or content of the user interface presented to the user (or other options, offers or invitations made available to the user). Usage patterns may be tracked by user, user units (e.g. family, room or cabin), location, activity, event, commercial enterprise or enterprise, etc. The user profile may be used to create unique user interactions and experiences during the visit to the site; advertising, marketing or other messages can be “targeted” to certain users or types of users based on their user profiles. A user may be given special “privileges” as a result of having achieved or been given a different “status” (e.g. as a frequent visitor, an affiliation with a group, a special promotion, age, etc.) and therefore may be given special offers or priority treatment during the visit (e.g. special pricing or discounts, enhanced access, early reservations, coupons, etc.).

Using the data that is available, the relationship between the user and the site (or commercial enterprises and other enterprises or other users or groups of users) may be personalized; in addition, the management of the site may track its own effectiveness, customer service, purchasing patterns, utilization of resources (including of the system and/or of access points or subsystems), etc.

### INFORMATION MANAGEMENT SYSTEM

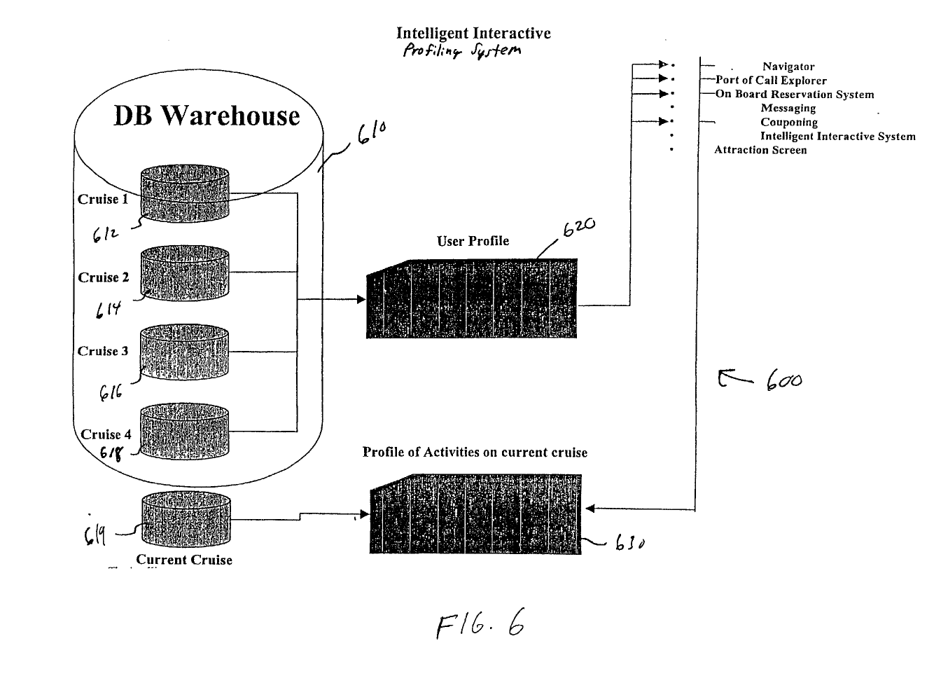

The Information Management subsystem allows the management of information regarding a particular site (e.g. the activities, destinations, events, and various other attractions on-site and off-site), the subsystems in operation at the site, and the users visiting the site. The subsystem uses information that is known and available to the management of the site (or any other affiliated enterprise) to build a user profile (FIG. 6). The subsystem may also allow the refinement of a user profile based on prior interactions with the system (or other information collected in connection with the visit to the site). This subsystem is intended to allow the management of a site to identify their users preferences by extracting and aggregating data from all other subsystems. As a result, it will be possible to differentiate users using “data mining” technologies and to profile and segment each user, and for management to develop a more comprehensive understanding of each user and to use this understanding to “customize” and/or “personalize” the experience of that user at the site; in addition, the user interface may be configured to present personalized options and/or privileges (or a special greeting) to each user based on the user profile.

The subsystem may also include a “comment card” function through which a user may provide information in the form of feedback or comments to the host of the system, or alternatively the management of the site.

### BUSINESS OPPORTUNITIES

The system and method is intended to promote beneficial commercial relationships between the host, the site and various commercial enterprises (e.g. vendors) and other enterprises, as well as users. Commercial enterprises and other enterprises may elect to link to the system by network or otherwise, provide advertising or couponing services through the user interface, or may wish to obtain information available and collected in connection with a visit by a user to the site, including information pertaining to usage patterns and user profiles. The host of the system or management of the site may maintain a registry of enterprises who have been qualified or selected to be affiliated and/or to link to provide advertising on the system. Such services may be made available for a fee.

### SITE SPECIFIC USER INFORMATION SYSTEM

Referring now to FIG. 1, cruise ship 100 is depicted. Cruise ship 100 includes a communications network 110 which may be a cruise ship communications network in the form of a wired network or a wireless network or any combination thereof using any of a variety of communications protocols including, but not limited to, transmission control protocol/internet protocol (TCP/IP), IEEE 802.11 protocols, and the like. A server 120 is in communication with communications network 110 and may include at least one database. Further, a terminal device 130 which may be any variety of terminal devices including, but not limited to touch screen kiosk type devices and portable electronic devices, is coupled to communications network 110 either by a wireless or wired communications link. Further, a radio (RF) transceiver 140 is in communication with communications network 110 and is configured to provide RF transmissions and to receive RF transmissions to and from a handheld computer 150 having an RF transceiver, or to and from any of a variety of other types of handheld and/or portable devices, such as, but not limited to, cellular telephones, laptop computers, and the like.

Handheld computer 150 is an exemplary embodiment of a terminal device and access device that provides similar functionalities as terminal device 130. User interfacers are configured on terminal devices 130 and handheld computers 150 so that a user may select options which will provide cruise ship passengers with information about cruise operations, activities, onboard and off board, and further provide other types of information, including, but not limited to navigation about the cruise ship, navigation off the cruise ship, reservation systems, advertising, messaging, account inquiry and management, and the like.

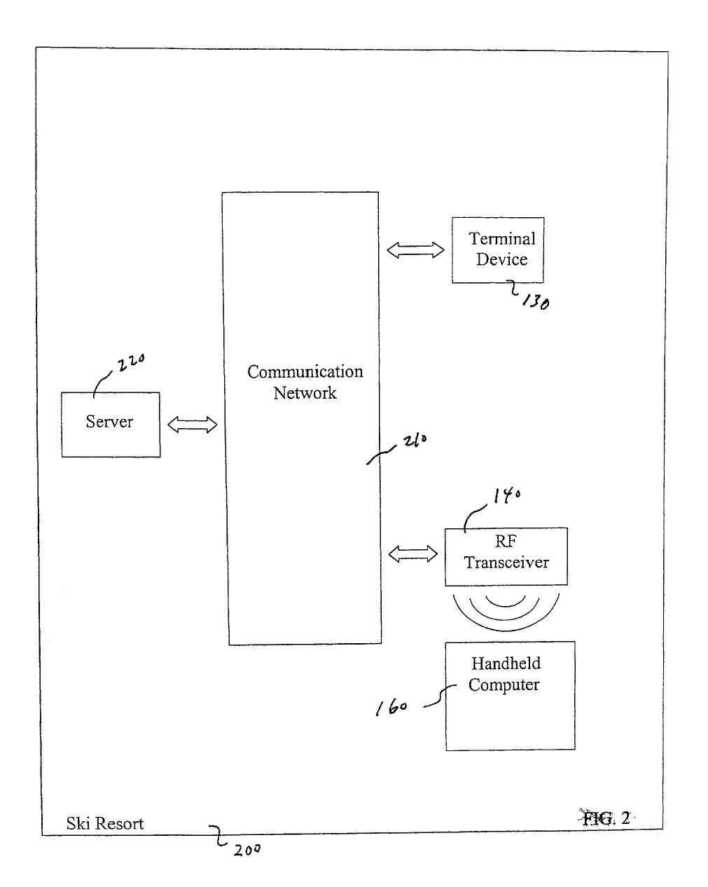

Referring now to FIG. 2, a ski resort 200 is depicted. Ski resort 200 is served by a communications network 210 in a similar manner as cruise ship communications network 110 serves cruise ship 100. Also similarly, ski resort 200 includes a server 220, at least one terminal device 230, at least one RF transceiver 240, and at least one handheld computer with an RF transceiver 260. In an exemplary embodiment, ski resort communications network 250 provides similar services to ski resort users as does cruise ship communications network 110 does to cruise ship passengers. For example, ski resort communications network 210 provides a plurality of data including, but not limited to, maps and navigation information, activities information, onsite reservation systems, out of resort excursion information and ticketing systems, ski resort messaging systems, ski resort information and data, such as, but not limited to weather data, off ski resort planning systems, ski resort account inquiry systems, advertising and couponing systems, ski lift and trail information, and the like.

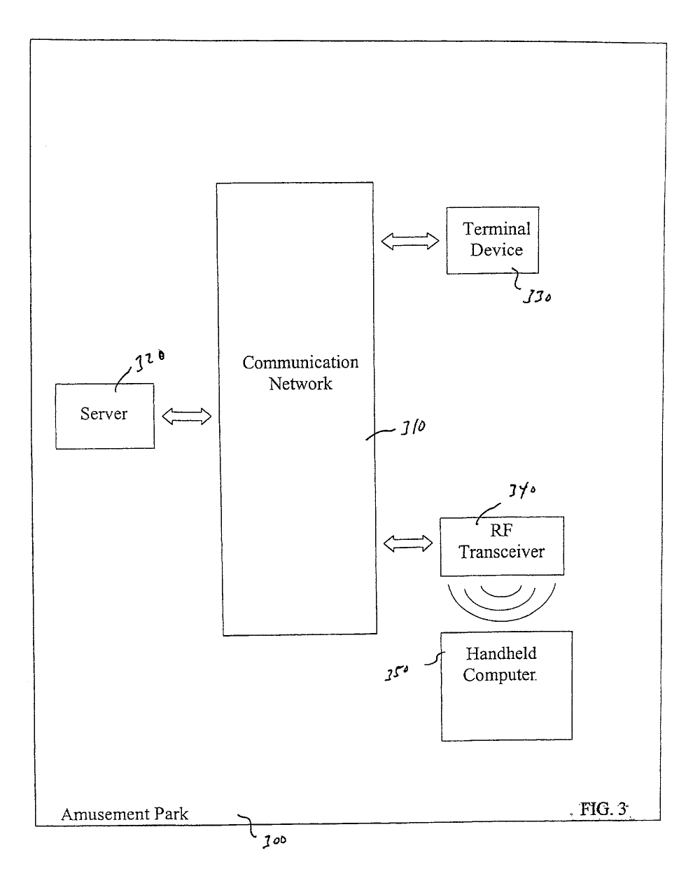

Referring now to FIG. 3, an amusement park 300 is depicted. Amusement park 300 includes a communications network 310, a server 320, at least one terminal device 330, at least one RF transceiver 340, and at least one handheld computer/RF transceiver 350 similar to the cruise ship system 100 and ski resort system 200 depicted in FIGS. 1 and 2. Amusement park communications network 310 is configured to provide amusement park visitors with amusement park related information such as, but not limited to those types of information which may be supplied to a user of any type of site that they are visiting similar to cruise ship 100 and ski resort 200 and further including amusement park information such as ride wait times, ride demand, ride line length, ride reservations, etc.

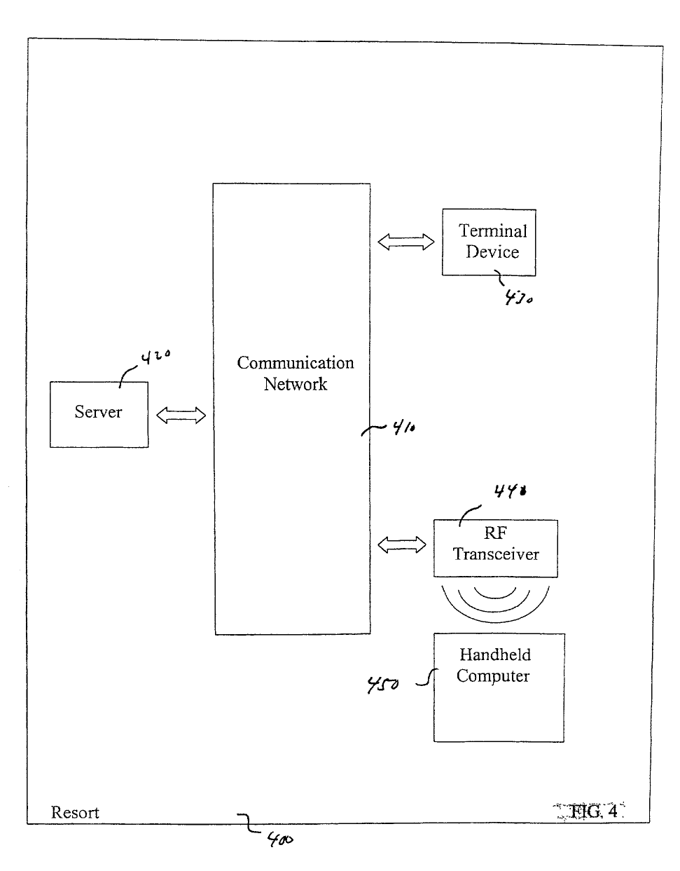

Referring now to FIG. 4, a generalized resort 400 or any other generalized site is depicted. Resort 400 includes communications network 410, a server 420, at least one terminal device 430, at least one RF transceiver 440, and at least one handheld computer 450, similar to the cruise ship system 100, ski resort system 200, and amusement park system 300 depicted in FIGS. 1-3. Resort 400 which may be representative of any of a variety of types of generic sites uses communications network 410 to provide resort users or site users with a plurality of information which is retrieved through any variety of devices such as terminal devices 430 or radio frequency devices 440 which are in communication with communications network 410 and server 420.

Referring now to FIG. 5, an exemplary communications networks, such as a cruise ship network 500 is depicted. Cruise ship network 500 includes a plurality of servers 510, a plurality of access points 520 and a plurality of wired connections 530 distributed throughout the cruise ship, e.g. Wired connections 530 may also be replaced with wireless connections and wireless access points distributed throughout cruise ship 500 or any other site. Communications network 500 may also be in communication with any of a variety of other communications networks such as, but not limited to, a satellite network 550 or any other communications network such as the internet 560. Satellite network 550 may be in communication with a plurality of other networks 551, a service provider technologies network 552 which is configured to provide information services to cruise ship network 500 in particular. Satellite network 550 may also be in communication with a remote user 553, to a customer network 554 or to a client network 555. Similarly, if network 500 is in communications with internet 560 it may also be in communications with other networks 551, a service provider technologies network 552, a remote user 553, a customer network 554 and/or client network 555. In general network 500 is configured to implement user interfaces at access points at a specified site such as a resort, ski resort, amusement park, cruise ship, hotel, hospital, airport, educational or corporate campus, etc. The information provided to the user of the specified site will be tailored to the specified site itself. Further access points and graphically user interfaces will also be tailored to the user of the sites. Network 500, depicted as a cruise ship communications network may be generally representative of a site specific communications network.

Referring now to FIG. 6, an exemplary embodiment of an intelligent interactive profiling system 600 is depicted. Such a system includes a database warehouse 610 including databases relating to a plurality of cruises 612, 614, 616, 618, etc. and further, a database 619 for the current cruise that is in operation 619. Intelligent interactive profiling system 600 is a software module that may be configured to gather data such as usage patterns by passengers, passenger units, location, events, businesses frequented on the repeated and new users activity through use of their interface monitor, etc. For example, when a new user is added to the database, a user profile 620 is started. The profile stores each event or option used by method of the interface, by the user. At the end of each cruise, or alternatively for another site, at the end of a specified event or time period, all profiles of each user are stored in a database warehouse 610. With each additional cruise (or event, or span of time), a profile is created from the combination of all prior cruises (or events or time periods). This data is utilized for specific advertisements and suggestions that are made upon use of the interface system. Simultaneously, a new profile is being created with each use of the interface system to later be stored in database warehouse 610 and then compiled into one user profile 620. A profile of activities on a current cruise or at a current event 630 may also be maintained. In an exemplary system intelligent interactive profiling system 600 may be used with a navigator system, a port of call explorer system, an on board reservation system, a messaging system, a couponing system, or independently thereof.

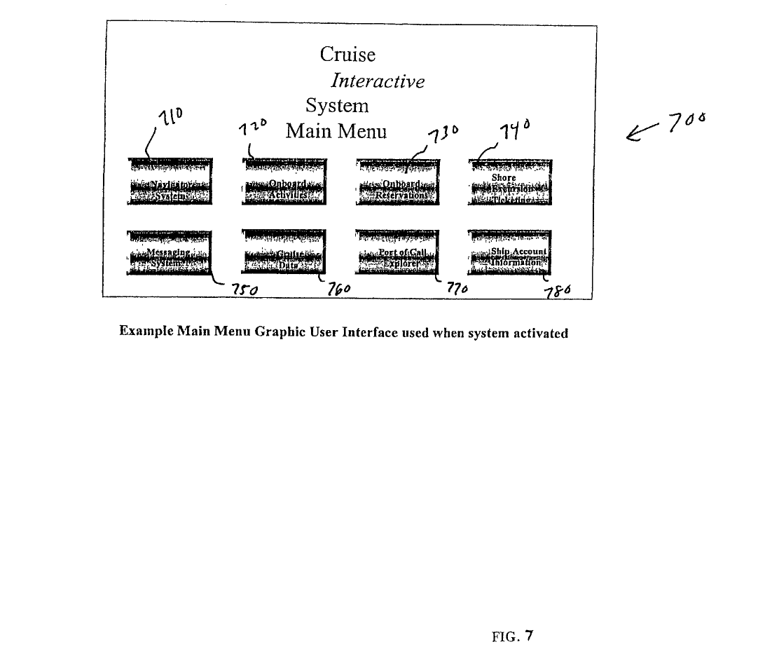

Referring now to FIG. 7, a user interface 700 is depicted. User interface 700 includes a plurality of user preferences in a main menu. User preferences may include, but are not limited to, a navigator system button 710, an onboard activities button 720, an onboard reservations system 730, a shore excursion ticketing button 740, a messaging system button 750, a cruise data button 760, a port of call explorer button 770, a ship account information button 780 and any other of a variety of buttons configured on a user interface for gaining access to functionality of the system. Interface 700 is exemplary of any of a variety of user interfaces, and is also exemplary of user interfaces which may be applied to different types of sites such as, but not limited to, a resort, ski resort, amusement park, cruise ship, hotel, hospital, airport, educational or corporate campus, and the like.

Referring now to FIG. 8, an exemplary system diagram is depicted showing user interface 700, as depicted in FIG. 7 as well as intelligent interactive profiling system 600 as depicted in FIG. 6. Profiling system 600 and interface 700 running on computing device technology 810 may be configured and connected in a system 800 to communicate with an in-house database 810 which is running on a server, such as server 120 of FIG. 1 and is configured to provide functionality necessary to provide a user of interface 700 with the desired information.

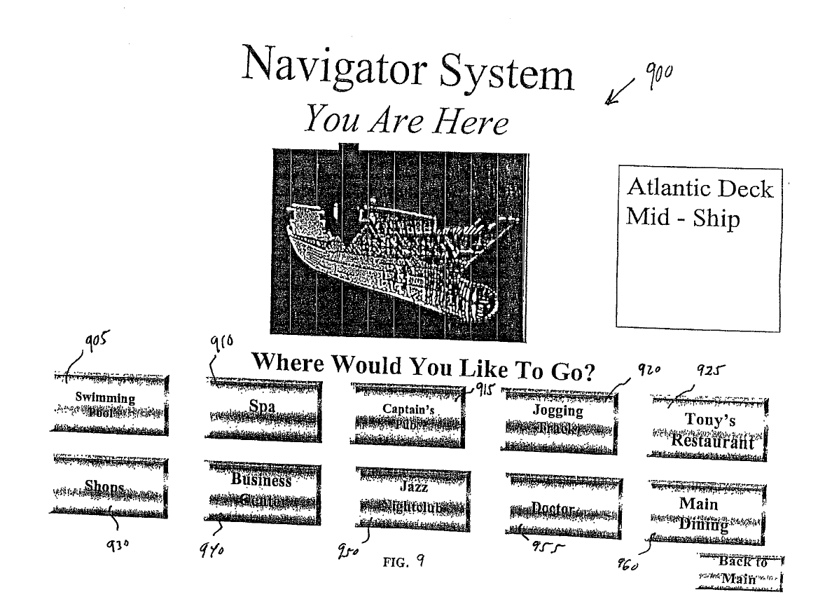

Referring now to FIG. 9, a user interface 900 for a navigator system is depicted. In an exemplary embodiment the navigator system is for a cruise ship. However, a navigator system as described may be applied to any of a variety of particular sites not limited to a cruise ship. In such a navigator system 900, a user may get directions to a variety of locations within a specified site, e.g., a cruise ship. For example, the navigator system interface 900 includes a plurality of buttons such as, but not limited to, a swimming pool button 905, a spa button 910, a Captain's Pub button 915, a jogging track button 920, a Tony's Restaurant button 925, a shop's button 930, a business center button 940, a night club button 950, a doctor button 955, and a main dining button 960. In an exemplary embodiment any of a variety of other types of buttons or selection features may be applied. Each button may be configured to correspond to a specified location within the site. In an exemplary embodiment if a user wishes to locate a spa, a user would select swimming pool button 905.

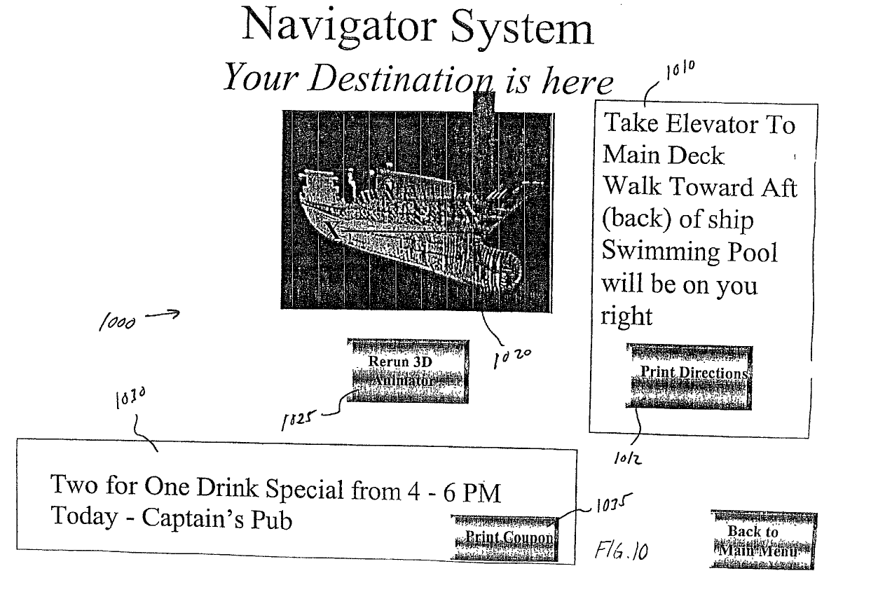

Directions and/or animations, maps, or the like will be provided on another screen such as screen 1000 depicted in FIG. 10. Screen 1000 includes a plurality of text directions 1010 in which a user is told how to locate the desired site, such as the swimming pool. In an exemplary embodiment a print directions button 1012 may be made available such that a user may print out textual directions. Further still a 3-D animation may be provided to a user in a window such as window 1020 to show a user a 3-D animation of the user's movement through the site to arrive at the desired destination. In an exemplary embodiment, a button to rerun the 3-D animation 1025 may be included such that a user may watch the animation a multiplicity of times. Further, 2-D maps or audio instructions may also be provided as well.

In a further exemplary embodiment, an advertisement 1030 may be included on screen 1000. Advertisements, such as advertisement 1030 may be included on any of the screens presented to the user, not limited to screen 1000. Advertisements may be of a generic type, or may be designed specifically for a specific type of user and may be provided based on the user profile generated from intelligent interactive profiling system 600. In an alternative exemplary embodiment, a user of screen 1000 may have the option of printing a coupon for a destination by using a button such as button 1035. Alternatively, a user using a handheld computer device may be able to save a coupon in the memory of the device and redeem the computer by interfacing with a device at the destination. In another alternative embodiment, a user may be able to select a coupon and have the coupon stored in a user account such that the coupon is automatically applied to the account if a user utilizes the advertised service.

Referring now to FIG. 11, a daily activities user interface screen 1100 is depicted. User interface screen 1100 is an introductory screen for daily activities for a site such as, but not limited to a cruise line. In operation, a user initiates the daily activities system by, for example, swiping a room card in a card reader, or entering a code (user name and password, e.g.), or any of a number of types of user authorization procedures. In an exemplary embodiment, the daily activities system provides on board information relating to activities and events in the cruise ship, or activities and events taking place at or around the specific site. Further, the activities system may be configured to present information which is tailored for the user according to predefined user data such as profiling data compiled by intelligent interactive profiling system 600 of FIG. 6. Further, the daily activities system may provide access to an activities reservation system such that a user may be able to make a reservation for the activities. Daily activities may include, but are not limited to classes such as training classes, exercise classes, and the like, competitions such as races, games, and the like, shows, such as magic shows, music shows, dance shows, and other entertainment shows, and the like. Further, the daily activities system may be used for providing access to information and reservations relating to any of a variety of daily activities at any of a variety of sites.

Referring now to FIG. 12, a dining reservation system 1200 is depicted. Dining reservation system 1200 is representative of a generalized reservation system for a cruise ship or any of a variety of other sites including, but not limited to, a resort, ski resort, amusement park, cruise ship, hotel, hospital, airport, educational or corporate campus, and the like. In operation, after a user enters the dining reservation system, a restaurant selection screen 1210 is displayed to a user. Restaurant selection screen 1210 may include a selection of restaurant buttons 1215 each corresponding to a different restaurant. Once a user selects a restaurant button, a user may be supplied with a variety of information including information about the particular restaurant in a restaurant information screen 1220, for example. Further, a user may choose to make a reservation by choosing a make reservation button 1225 or by selecting a view sample menu to view a sample menu by depressing button 1226. Further, any of a variety of other button configurations and screen display configurations may be used. Reservation system 1200 utilizes a database 1230 which stores information related to each of the particular restaurants. Further, a user may also utilize a search screen 1240 which may be able to allow a user to search for particular restaurants or types of restaurants or food types and/or may be able to list the appropriate restaurants and allow a user to scroll up through the list using a scroll up button 1242 or scroll down through the list using a scroll down button 1244.

Referring now to FIG. 13, once a user of dining reservation system 1200 chooses a restaurant in which to dine, a user may be prompted with a user interface screen 1310 in which the prospective diner is able to choose a dinner reservation time 1312. In an exemplary embodiment, the prospective diner may change the time by any of a variety of ways including, but not limited to utilizing time increment buttons 1314 and 1316. The chosen dining time is communicated to the database 1230. If it is found that the requested dining time is not available, a user will be prompted with a user interface screen such as but not limited to screen 1320 in which an alternative time may be chosen. If, however, the requested dining time is available, a user may be prompted with a user interface screen such as screen 1330 in which a reservation may be confirmed.

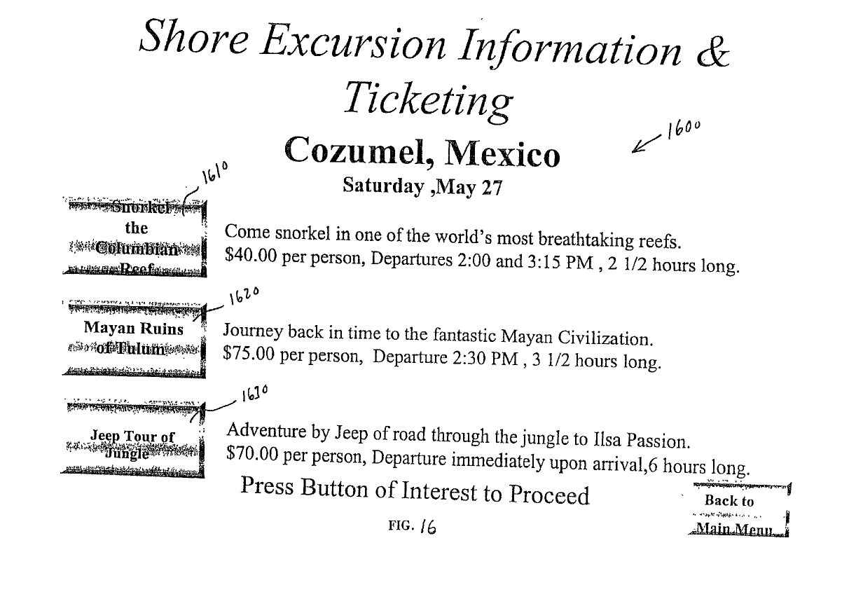

Referring now to FIGS. 14-16, a shore excursion information ticketing system 1400 is depicted. System 1400 includes a ticketing system for sites off of the cruise ship or, alternatively, off or out of the specified site. In an exemplary embodiment, a user is provided with a user interface screen 1600 (FIG. 16) which provides a user with a choice of excursion destinations outside of the particular site. In an exemplary embodiment, the excursion information and ticketing system may provide a plurality of selections for excursions, such as but not limited to a snorkel excursion 1610, a Mayan ruins tour 1620, and a jeep tour of the jungle 1630. However, it should be noted that any of a variety of excursion destinations may be embodied by selections or buttons on a user interface screen. To proceed, a user would choose one of button 1610, 1620, and 1630. If, for example, button 1620 is chosen, a user may be provided with a ticketing screen or ticketing user interface 1410 in which a user will select a number of tickets 1420 that it wishes to purchase by utilizing increment buttons 1430 and 1435. Once the user is finished selecting the number of tickets, a confirmation screen or interface 1440 is presented to the user and, in an exemplary embodiment, a user may choose to print tickets using a print tickets button 1445. In other exemplary embodiments, a user may maintain an electronic ticket in a device such as, but not limited to a handheld computer being used by the user. Further, in an alternative embodiment, tickets may be stored in a database and, therefore, an actual paper ticket may not be needed. For example, a user may just need to present identification at a ticketing window where an attendant accesses a ticket database and the user simply provides identification such as a driver's license, a passport, etc. In a further exemplary embodiment, a user account may be automatically debited upon purchase of the tickets.

Referring now to FIGS. 17 and 18, a site messaging system such as cruise line messaging system 1700 is depicted. Messaging system 1700 is intended to allow communication between users within the site and possibly others off site and in a particular embodiment on a cruise ship. To begin using the messaging system, a user accesses the messaging system through an access user interface 1710. In a particularly preferred embodiment, a user swipes a room card in a card reader to begin. Further, in a particularly preferred embodiment, a user then enters the cabin room number in a user interface screen 1720. Once an authorization to use messaging system 1700 has been approved, a messaging system selection screen 1730 (FIG. 18) is presented to a user in which a user chooses to either leave a message by selecting button 1740 or retrieve a message by selecting button 1750. In other exemplary embodiments, a user may be using a personalized handheld computer in which messages are automatically received via a wireless communications link from an account on the site specific communications system.

Referring now to FIG. 19, another exemplary feature of the site information system may include a site information center such as a cruise information or data information system. The cruise information system may include a cruise information center menu screen 1900. Interface 1900 may include any of a variety of information selections including but not limited to a weather button 1910, a position button 1920, an estimated time of arrival (ETA) button 1930, and a speed of vessel button 1940. Further, any of a variety of other types of buttons or selections may be used which are tailored to the site. For example, a ski resort data system may include elevation information, weather forecasting information, estimated skiing time for a given skiing run, snow condition information, and the like.

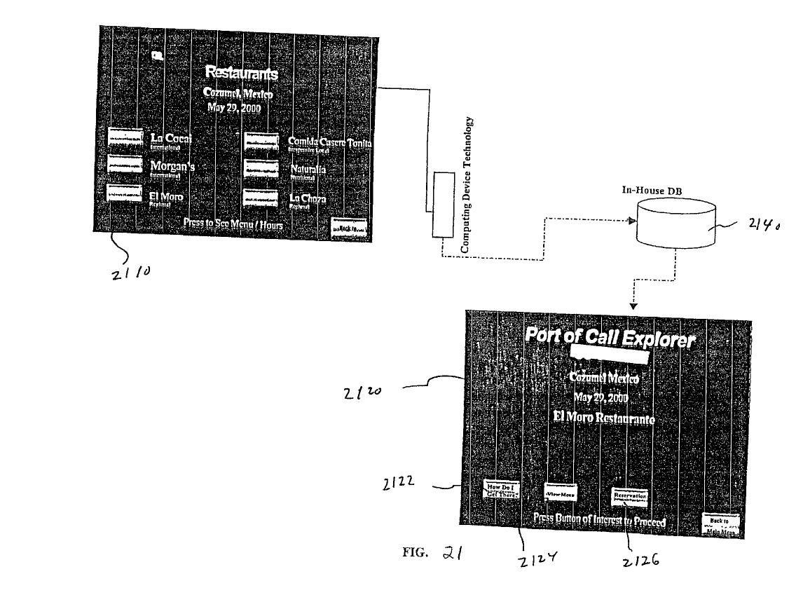

Referring now to FIG. 20, an explorer system 2000 is depicted. Explorer system 2000 includes an introductory interface or accessing interface 2010 in which a user is requested to swipe a room card or provide any other authorizing identification such as a user name and password. The explorer system 2000 may be adapted to any particular site which may provide references to destinations that are accessible at each port of call in the cruise ship embodiment, or provide reference to destinations at or near the particular site. In a particularly preferred exemplary embodiment, once access to the explorer system is authorized, a user may be prompted with a choice of destinations interface screen 2020. Interface screen 2020 may include a plurality of destination buttons 2022, 2024, 2026, and 2028. A user would then select one of buttons 2022, 2024, 2026, and 2028 based on which destination there is interest. In an exemplary embodiment, once a destination is chosen, any of a variety of associated categories may be presented, such as sites of interest, restaurants, shopping, night life, or other commercial enterprises. For example, referring now to FIG. 21, a restaurant interface screen 2110 is depicted showing buttons associated with the various restaurants in the selected destination (Cozumel, Mexico). Once a restaurant is chosen, a plurality of other selections may be presented to a user, such as, but not limited to selections presented on a screen 2120 including direction button 2122, a restaurant menu button 2124 and a reservation button 2126. Accordingly, a user will be provided up to date information retrieved from database 2140 without having to consult extraneous paper, pamphlets, or brochures, or without having to ask an information officer. Further, in an exemplary embodiment, a user may be able to gain access to the explorer system using a wireless handheld computing device which may be issued to the user upon entry onto the cruise ship, or entry into the site, such as a resort, ski resort, amusement park, cruise ship, hotel, hospital, airport, educational or corporate campus, or the like. Further still, in an exemplary embodiment, explorer system 2000 may provide a network connection to an off-site navigation database, the off-site navigation database providing information relating to locations outside of the specified site.

Referring now to FIG. 22, an account inquiry system 2200 is depicted. Account inquiry system 2200 interfaces with a database 2210 which keeps records of accounts for users of the particular site including the cruise ship. For example, a ship account inquiry user interface access screen 2220 may be displayed to a user in which a user provides authorization to access the account inquiry system. In an exemplary embodiment, the user then accesses a specific account by inputting a code representative of the account such as, but not limited to a cabin room number in a user interface screen 2230. Information that may be retrieved for a particular user may include but is not limited to a history of transactions, such as all transactions by choosing an all transactions button 2310 in FIG. 23 which depicts an account inquiry system inquiry choice screen 2300. In an exemplary embodiment, the statement may be printed using a print statement button 2320 or any of a variety of other tasks may be accomplished including listing a selected set of transactions such as the last five transactions using button 2330. Further, any of a variety of other inquiries may be included such as, but not limited to account fund transfers, formation and management of subaccounts, wiring of funds, management of accounts, etc.

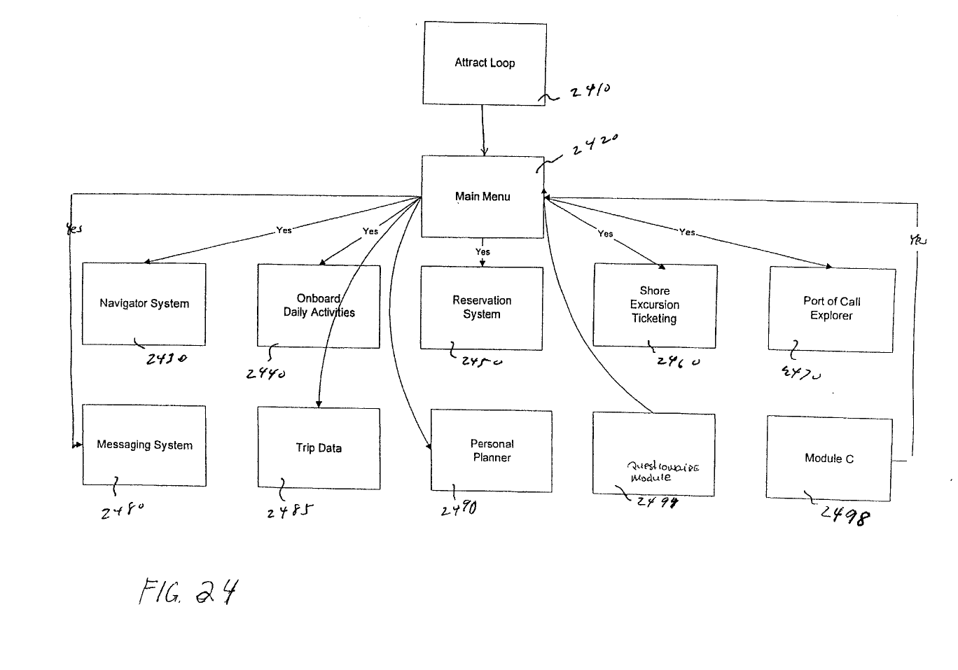

Referring now to FIG. 24, when a user enters a site, a number of different methodologies may be used for providing a site user with access to the site specific user information system. For example, a plurality of kiosks or information access devices may be placed throughout the site itself. Users of the site may easily access the access devices and the information system by interfacing any of the access devices. Further, in an alternative embodiment, users may utilize their own portable electronic devices to receive information from the information system and/or to communicate with the information system. For example, a cellular telephone may be used to interface with the site specific information system by using a wireless access protocol or the like. Similarly, a user may be able to interface with the information system by utilizing a handheld computer including either an infrared transmitter and receiver and/or a radio frequency (RF) transceiver. In an exemplary embodiment, the use of a infrared transceiver requires that the user approach any of a variety of access points to communicate with the information system. Similarly, a user using a handheld or portable computer having an RF transceiver may roam the site and always have access to and be in communication with the information system via the wireless radio frequency link. In another exemplary embodiment, the user of a site may be supplied with a portable access device such as a handheld computer with an RF transceiver therein to access the information system while using the site. In an exemplary embodiment, the user would be charged a user fee for using the device or would be charged an access fee for their utilization of the communications network itself. Further still, the user may be provided with a handheld or portable electronic device that is configured to receive and communicate information over the information system, the handheld or portable computer being supplied by the site management and marketing at no extra cost to the user.

Once the user has access to the information system, an attraction screen or attraction loop may be shown to a user and provide them with a main menu (see FIG. 24, 2410 and 2420). A main menu 2420 provides access to any of a variety of sub-information systems including, but not limited to a navigator system 2430, a daily activities system 2440, a reservation system 2450, a shore excursion ticketing system 2460, a port of call explorer 2470, a messaging system 2480, a trip data system 2485, a personal planner 2490, a questionnaire module 2494 and any of a variety of other software modules 2498.

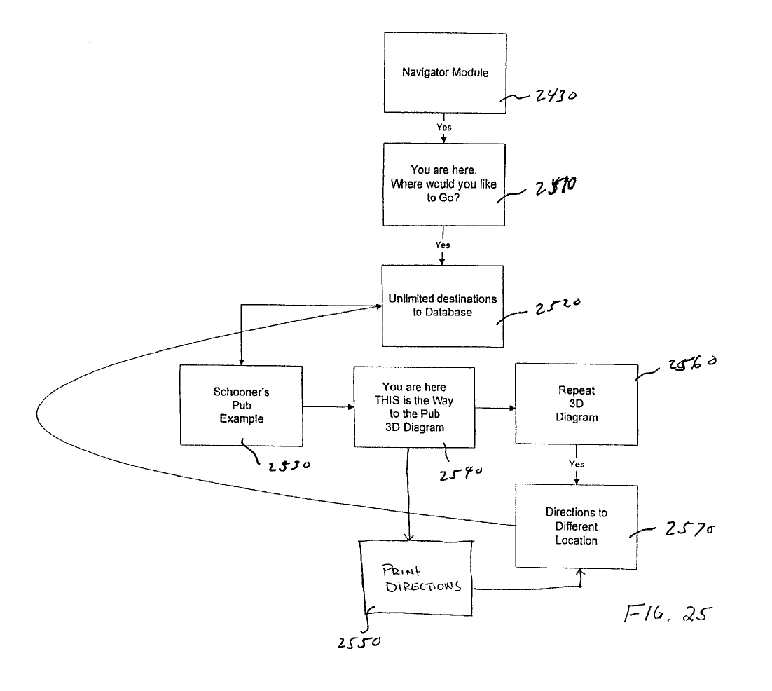

Referring now to FIG. 25, if navigator module 2430 is chosen, a user is prompted as to where they would like to go (step 2510). A plurality of destinations may be stored in the database or further an unlimited number of destinations may be stored or calculated. If a user has a proposed destination, such as, but not limited to a pub (step 2530), the user may be provided with a 3 dimensional diagram of the directions to the pub (step 2540) or alternatively a plurality of directions may be provided to the user either in printed form or in an electronic format (step 2550). Further, in an exemplary embodiment, a map (2-D) may be provided to the user. Further still, a user may ask to repeat a three dimensional (3-D) diagram (step 2560) or further may be asked to get directions to a different destination (step 2570).

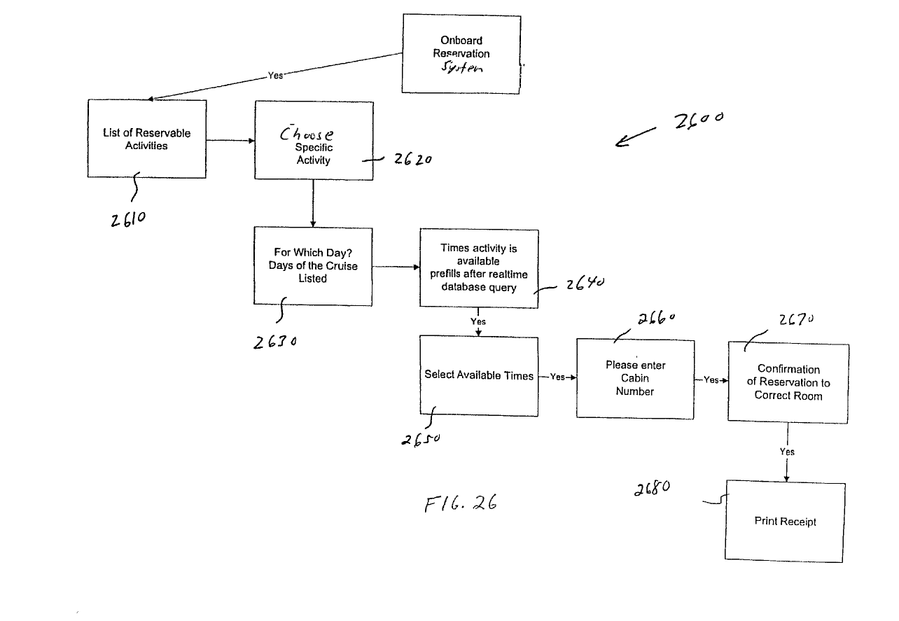

Referring now to FIG. 26, a process diagram for an exemplary on board reservation system 2600 is depicted. System 2600 may include a list of reservable activities that are presented to a user (step 2610). After a specific activity is chosen (step 2620), a day is chosen for the activity (step 2630). Next, the times that the activity is available may be provided to the user (step 2640) after a real time database query. A user then selects the available time of their choice (step 2650) and then authorizes the reservation by entering a cabin number or other like identifier (step 2660) and confirms the reservation to the correct room number (step 2670). Optionally, a printed receipt is then provided to the user (step 2680).

Similar processes and systems and steps may be used for any of the sub-information systems related to the site specific information system. For example, the account inquiry system, the site information center, an off site excursion information ticketing system, an advertising/couponing system, a daily activities system, a explorer system, a messaging system, and the like may all utilize a hierarchical design or relational design to access information and to provide interaction between a user and the site specific information system.

Referring now to FIG. 27, an exemplary depiction of systems which may be employed to enable a site specific information system are depicted. System 2700 includes a handheld computer 2710 which is enabled with wireless connectivity. The wireless connectivity may be over a radio frequency link and include an RF receiving tower 2712 which is coupled to and in communication with a handheld gateway 2714. Handheld gateway 2714 may be in communication with a web server 2720 via a hypertext transfer protocol (http) link and may receive hyper text markup language (html) pages therefrom. Similarly, a mobile phone 2730 may be used to gain access to the plurality of site specific information services via a wireless link provided by receiving tower 2732 which is coupled to a wireless access protocol (wap) gateway 2734. The wap gateway is then connected to web server 2720 by an http connection and communicates wireless markup language (wml) documents over the communications link to mobile phone 2730. Similarly still, a ground based phone or wired phone 2740 may also be used via a voice (vox) server 2744 and connected to web server 2720 by an http link from which vox markup language (voxml) documents may be received from web server 2720 and converted to voice and delivered to ground phone 2740.

It should further be noted that the hardware and software systems described above with specific reference to cruise ships, may be tailored to fit and serve any particular defined site, not limited to the cruise ship environment. Generally, any site in which visitors to the site would be aided with site specific information are equally applicable.

It will be understood that the foregoing description is of preferred and exemplary embodiments and that the inventions disclosed are not limited to the specific forms shown. For example, the methods may be performed in any of a variety of sequence of steps. It is important to note that the system and method is capable of being implemented in any of a wide variety of arrangements of computing devices, networking equipment, other hardware and/or software, operating systems, programming languages, and is not intended to be limited in scope in this manner. It should be noted that the destinations, events, and various other attractions and activities shown in the cruise ship (site) of FIGS. 1 and 5, are only representative of the wide variety of such subject matter that may be available at or through a site according to other embodiments of the system and method. These and other modifications may be made in the system and method and other arrangements of the elements without departing from the scope of the inventions as disclosed and/or as expressed in the appended claims.

What is claimed is:

1. A passenger information system for a cruise ship, comprising:
a communications network;
a server coupled to the communications network;
a terminal device including a processor and a display, the terminal device in communications with the communications network and configured to access information from the server; and
a user interface provided on the display of the terminal device, the user interface including user selectable options and configured to selectively provide passenger information to a cruise ship passenger.

2. The passenger information system of claim 1, wherein the communications network is a cruise ship communications network.

3. The passenger information system of claim 1, wherein the terminal device is a kiosk device.

4. The passenger information system of claim 1, wherein the terminal device is a handheld computer including a radio frequency transceiver.

5. The passenger information system of claim 1, wherein the communications network includes at least one RF transceiver coupled thereto and configured to provide communications with the handheld computer.

6. The passenger information system of claim 1, wherein the communications network includes an off-ship communications network.

7. The passenger information system of claim 1, wherein the server includes an application service provider server.

8. The passenger information system of claim 1, wherein one of the user selectable options includes a navigator system.

9. The passenger information system of claim 8, wherein the navigator system is configured to provide maps to the user.

10. The passenger information system of claim 8, wherein the navigator system is configured to provide directions to the user.

11. The passenger information system of claim 8, wherein the navigator system is configured to identify destinations on the cruise ship.

12. The passenger information system of claim 8, wherein the navigator system is configured to provide a three dimensional graphical representation of at least a portion of the cruise ship.

13. The passenger information system of claim 8, wherein the navigator system is configured to provide directions to a requested destination.

14. The passenger information system of claim 13, wherein the navigator system is configured to provide advertising associated with the requested destination.

15. The passenger information system of claim 13, wherein the navigator system is configured to provide coupons associated with the requested destination.

16. The passenger information system of claim 1, wherein one of the user selectable options includes an explorer system.

17. The passenger information system of claim 16, wherein the explorer system is configured to provide maps of off-ship destinations to the user.

18. The passenger information system of claim 16, wherein the explorer system is configured to provide directions to off-ship destinations to the user.

19. The passenger information system of claim 16, wherein the explorer system is configured to identify destinations off the cruise ship.

20. The passenger information system of claim 16, wherein the explorer system is configured to provide a three dimensional graphical representation of at least a portion off-ship destination.

21. The passenger information system of claim 16, wherein the explorer system is configured to provide directions to a requested destination.

22. The passenger information system of claim 21, wherein the explorer system is configured to provide advertising associated with the requested destination.

23. The passenger information system of claim 21, wherein the explorer system is configured to provide coupons associated with the requested destination.

24. The passenger information system of claim 16, wherein the explorer system is configured to provide currency exchange information.

25. The passenger information system of claim 16, wherein the explorer system is configured to provide a link to information relating to a requested destination.

26. The passenger information system of claim 16, wherein the explorer system includes access to a reservation system configured to enable reservations relating to a requested destination.

27. The passenger information system of claim 16, wherein the explorer system includes a navigation database link, the navigation database link configured to provide navigation and location information for locations off the cruise ship.

28. The passenger information system of claim 1, wherein one of the user selectable options includes an activities system.

29. The passenger information system of claim 28, wherein the activities system is configured to provide on-board information relating to activities and events on the cruise ship.

30. The passenger information system of claim 28, wherein the activities system is configured to provide information tailored for the user according to predefined user data.

31. The passenger information system of claim 28, wherein the activities system is configured to provide access to an activities reservation system.

32. The passenger information system of claim 1, wherein one of the user selectable options includes a cruise ship reservation system.

33. The passenger information system of claim 32, wherein the reservation system provides options for cruise ship dining reservations.

34. The passenger information system of claim 32, wherein the reservation system provides options for activities on the cruise ship.

35. The passenger information system of claim 32, wherein the reservation system includes providing a ticket for a reserved event.

36. The passenger information system of claim 35, wherein the ticket is an electronic ticket comprising data stored on an electronic device.

37. The passenger information system of claim 1, wherein one of the user selectable options includes an off-ship excursion system.

38. The passenger information system of claim 37, wherein the off-ship excursion system is configured to provide a user with information relating to one or more destinations off the cruise ship.

39. The passenger information system of claim 37, wherein the off-ship excursion system is configured to provide at least one of tickets and reservations to destinations off the cruise ship.

40. The passenger information system of claim 1, wherein one of the user selectable options includes a passenger messaging system.

41. The passenger information system of claim 40, wherein the passenger messaging system provides text messaging between passengers on the ship.

42. The passenger information system of claim 40, wherein the passenger messaging system includes audio messaging between passengers on the ship.

43. The passenger information system of claim 40, wherein the passenger messaging system includes video messaging between passengers on the ship.

44. The passenger information system of claim 40, wherein the passenger messaging system includes an internet conduit configured for sending and receiving messages over the internet.

45. The passenger information system of claim 1, wherein one of the user selectable options includes a cruise ship data system.

46. The passenger information system of claim 45, wherein the cruise ship data system includes ship location information.

47. The passenger information system of claim 45, wherein the cruise ship data system includes weather forecast information.

48. The passenger information system of claim 45, wherein the cruise ship data system includes estimated time of arrival information.

49. The passenger information system of claim 45, wherein the cruise ship data system includes speed of travel information.

50. The passenger information system of claim 45, wherein the cruise ship data system includes audio information.

51. The passenger information system of claim 45, wherein the cruise ship data system includes graphical information.

52. The passenger information system of claim 1, wherein one of the user selectable options includes a port of call data system.

53. The passenger information system of claim 52, wherein the port of call data system provides information relating to destinations at ports of call.

54. The passenger information system of claim 52, wherein the port of call data system includes currency exchange information.

55. The passenger information system of claim 52, wherein the port of call data system includes direction information to destinations at ports of call.

56. The passenger information system of claim 52, wherein the port of call data system includes a reservation system for activities at ports of call.

57. The passenger information system of claim 52, wherein the port of call data system includes a link to destination information provided over an internet link.

58. The passenger information system of claim 1, wherein one of the user selectable options includes an account information system.

59. The passenger information system of claim 58, wherein the account information system includes cruise ship transactions.

60. The passenger information system of claim 58, wherein the account information system includes an account status option.

61. The passenger information system of claim 58, wherein the account information system includes an option to create subaccounts.

62. The passenger information system of claim 1, wherein one of the user selectable options includes a muster information system.

63. The passenger information system of claim 62, wherein the muster information system includes lifeboat location information.

64. The passenger information system of claim 63, wherein the muster information includes emergency information.

65. The passenger information system of claim 1, wherein one of the user selectable options includes an advertising system.

66. The passenger information system of claim 65, wherein the advertising system includes a couponing system.

67. The passenger information system of claim 65, wherein the advertising system includes information relating to businesses on the cruise ship.

68. The passenger information system of claim 65, wherein the advertising system includes information relating to businesses at ports of call.

69. A user information system for a ski resort, comprising:
a communications network;
a server coupled to the communications network;
a terminal device including a processor and a display, the terminal device in communications with the communications network and configured to access information from the server; and
a user interface provided on the display of the terminal device, the user interface including user selectable options and configured to selectively provide user information to a ski resort user.

70. The user information system of claim 69, wherein the communications network is a ski resort communications network.

71. The user information system of claim 69, wherein the terminal device is a kiosk device.

72. The user information system of claim 69, wherein the terminal device is a handheld computer including a radio frequency transceiver.

73. The user information system of claim 69, wherein the communications network includes at least one RF transceiver coupled thereto and configured to provide communications with the handheld computer.

74. The user information system of claim 69, wherein the communications network includes a wireless communications network.

75. The user information system of claim 69, wherein the server includes an application service provider server.

76. The user information system of claim 69, wherein one of the user selectable options includes a navigator system.

77. The user information system of claim 76, wherein the navigator system is configured to provide maps to the user at the terminal device.

78. The user information system of claim 76, wherein the navigator system is configured to provide directions to the user.

79. The user information system of claim 76, wherein the navigator system is configured to identify destinations within the ski resort.

80. The user information system of claim 76, wherein the navigator system is configured to provide a three dimensional graphical representation of at least a portion of the ski trails.

81. The user information system of claim 76, wherein the navigator system is configured to provide directions to a requested destination.

82. The user information system of claim 81, wherein the navigator system is configured to provide advertising associated with the requested destination.

83. The user information system of claim 81, wherein the navigator system is configured to provide coupons associated with the requested destination.

84. The user information system of claim 69, wherein one of the user selectable options includes an explorer system.

85. The user information system of claim 84, wherein the explorer system is configured to provide maps, to destinations outside of the ski resort, to the user.

86. The user information system of claim 84, wherein the explorer system is configured to provide directions, to destinations outside of the ski resort, to the user.

87. The user information system of claim 84, wherein the explorer system is configured to identify destinations outside of the ski resort.

88. The user information system of claim 84, wherein the explorer system is configured to provide a three dimensional graphical representation of at least a portion of areas surrounding the ski resort.

89. The user information system of claim 84, wherein the explorer system is configured to provide directions to a requested destination.

90. The user information system of claim 89, wherein the explorer system is configured to provide advertising associated with the requested destination.

91. The user information system of claim 89, wherein the explorer system is configured to provide coupons associated with the requested destination.

92. The user information system of claim 84, wherein the explorer system is configured to provide ski services information.

93. The user information system of claim 84, wherein the explorer system is configured to provide a link to information relating to a requested destination.

94. The user information system of claim 84, wherein the explorer system includes access to a reservation system configured to enable reservations relating to a requested destination.

95. The user information system of claim 84, wherein the explorer system includes a navigation database link, the navigation database link configured to provide navigation and location information for locations outside of the ski resort.

96. The user information system of claim 69, wherein one of the user selectable options includes an activities system.

97. The user information system of claim 96, wherein the activities system is configured to provide ski resort information relating to activities and events at the ski resort.

98. The user information system of claim 96, wherein the activities system is configured to provide information relating to ski lift wait times.

99. The user information system of claim 96, wherein the activities system is configured to provide access to a ski resort reservation system.

100. The user information system of claim 69, wherein one of the user selectable options includes a ski resort reservation system.

101. The user information system of claim 100, wherein the reservation system provides options for ski resort dining reservations.

102. The user information system of claim 100, wherein the reservation system provides options for activities at the ski resort.

103. The user information system of claim 100, wherein the reservation system includes providing a ticket for a reserved event.

104. The user information system of claim 103, wherein the ticket is an electronic ticket comprising data stored on an electronic device.

105. The user information system of claim 69, wherein one of the user selectable options includes an excursion system.

106. The user information system of claim 69, wherein one of the user selectable options includes a ski resort user messaging system.

107. The user information system of claim 106, wherein the ski resort user messaging system provides text messaging between ski resort users at the resort.

108. The user information system of claim 106, wherein the ski resort user messaging system includes audio messaging between ski resort users at the resort.

109. The user information system of claim 106, wherein the ski resort messaging system includes video messaging between ski resort users at the resort.

110. The user information system of claim 106, wherein the ski resort messaging system includes an internet conduit configured for sending and receiving messages over the internet.

111. The user information system of claim 69, wherein one of the user selectable options includes a ski resort data system.

112. The user information system of claim 111, wherein the ski resort data system includes elevation information.

113. The user information system of claim 111, wherein the ski resort data system includes weather forecast information.

114. The user information system of claim 111, wherein the ski resort data system includes estimated skiing time for a given ski run.

115. The user information system of claim 111, wherein the ski resort data system includes snow condition information.

116. The user information system of claim 111, wherein the ski resort data system includes audio information.

117. The user information system of claim 111, wherein the ski resort data system includes graphical information.

118. The user information system of claim 69, wherein one of the user selectable options includes an account information system.

119. The user information system of claim 118, wherein the account information system includes ski resort transactions.

120. The user information system of claim 118, wherein the account information system includes an account status option.

121. The user information system of claim 118, wherein the account information system includes an option to create subaccounts.

122. The user information system of claim 69, wherein one of the user selectable options includes an emergency information system.

123. The user information system of claim 122, wherein the emergency information system includes an injured skier reporting option.

124. The user information system of claim 122, wherein the emergency information system includes ski resort warning information.

125. The user information system of claim 69, wherein one of the user selectable options includes an advertising system.

126. The user information system of claim 125, wherein the advertising system includes a couponing system.

127. The user information system of claim 125, wherein the advertising system includes information relating to businesses at the ski resort.

128. The user information system of claim 126, wherein the advertising system includes information relating to ski equipment businesses.

129. A user information system for an amusement park, comprising:
a communications network;
a server coupled to the communications network;
a terminal device including a processor and a display, the terminal device in communications with the communications network and configured to access information from the server; and
a user interface provided on the display of the terminal device, the user interface including visitor selectable options and configured to selectively provide visitor information to an amusement park visitor.

130. The user information system of claim 129, wherein the communications network is an amusement park communications network.

131. The user information system of claim 129, wherein the terminal device is a kiosk device.

132. The user information system of claim 129, wherein the terminal device is a handheld computer including a radio frequency transceiver.

133. The user information system of claim 129, wherein the communications network includes at least one RF transceiver coupled thereto and configured to provide communications with the handheld computer.

134. The user information system of claim 129, wherein the communications network includes an out of park communications network.

135. The user information system of claim 129, wherein the server includes an application service provider server.

136. The user information system of claim 129, wherein one of the visitor selectable options includes a navigator system.

137. The user information system of claim 136, wherein the navigator system is configured to provide maps to the visitor.

138. The user information system of claim 136, wherein the navigator system is configured to provide directions to the visitor.

139. The user information system of claim 136, wherein the navigator system is configured to identify destinations in the amusement park.

140. The user information system of claim 136, wherein the navigator system is configured to provide a three dimensional graphical representation of at least a portion of the amusement park.

141. The user information system of claim 136, wherein the navigator system is configured to provide directions to a requested destination.

142. The user information system of claim 141, wherein the navigator system is configured to provide advertising associated with the requested destination.

143. The user information system of claim 141, wherein the navigator system is configured to provide coupons associated with the requested destination.

144. The user information system of claim 129, wherein one of the visitor selectable options includes an explorer system.

145. The user information system of claim 144, wherein the explorer system is configured to provide maps of out of park destinations to the visitor.

146. The user information system of claim 144, wherein the explorer system is configured to provide directions to out of park destinations to the visitor.

147. The user information system of claim 144, wherein the explorer system is configured to identify destinations out of the amusement park.

148. The user information system of claim 144, wherein the explorer system is configured to provide a three dimensional graphical representation of at least a portion out of park destination.

149. The user information system of claim 144, wherein the explorer system is configured to provide directions to a requested destination.

150. The user information system of claim 149, wherein the explorer system is configured to provide advertising associated with the requested destination.

151. The user information system of claim 149, wherein the explorer system is configured to provide coupons associated with the requested destination.

152. The user information system of claim 144, wherein the explorer system is configured to provide a link to information relating to a requested destination.

153. The user information system of claim 144, wherein the explorer system includes access to a reservation system configured to enable reservations relating to a requested destination.

154. The user information system of claim 129, wherein one of the visitor selectable options includes an activities system.

155. The user information system of claim 154, wherein the activities system is configured to provide park information relating to activities and events on the amusement park.

156. The user information system of claim 154, wherein the activities system is configured to provide information tailored for the visitor according to predefined visitor data.

157. The user information system of claim 154, wherein the activities system is configured to provide access to an activities reservation system.

158. The user information system of claim 129, wherein one of the visitor selectable options includes an amusement park reservation system.

159. The user information system of claim 158, wherein the reservation system provides options for amusement park dining reservations.

160. The user information system of claim 158, wherein the reservation system provides options for activities at the amusement park.

161. The user information system of claim 158, wherein the reservation system includes providing a ticket for a reserved event.

162. The user information system of claim 161, wherein the ticket is an electronic ticket comprising data stored on an electronic device.

163. The user information system of claim 129, wherein one of the visitor selectable options includes an out of park excursion system.

164. The user information system of claim 163, wherein the off-park excursion system is configured to provide a visitor with information relating to one or more destinations out of the amusement park.

165. The user information system of claim 163, wherein the out of park excursion system is configured to provide at least one of tickets and reservations to destinations out of the amusement park.

166. The user information system of claim 129, wherein one of the visitor selectable options includes a visitor messaging system.

167. The user information system of claim 166, wherein the visitor messaging system provides text messaging between visitors at the amusement park.

168. The user information system of claim 166, wherein the visitor messaging system includes audio messaging between visitors at the amusement park.

169. The user information system of claim 166, wherein the visitor messaging system includes video messaging between visitors at the amusement park.

170. The user information system of claim 166, wherein the visitor messaging system includes an internet conduit configured for sending and receiving messages over the internet.

171. The user information system of claim 129, wherein one of the visitor selectable options includes an account information system.

172. The user information system of claim 171, wherein the account information system includes amusement park transactions.

173. The user information system of claim 171, wherein the account information system includes an account status option.

174. The user information system of claim 171, wherein the account information system includes an option to create subaccounts.

175. The user information system of claim 129, wherein one of the visitor selectable options includes an emergency services information system.

176. The user information system of claim 175, wherein the emergency services information system includes first-aid information.

177. The user information system of claim 129, wherein one of the visitor selectable options includes an advertising system.

178. The user information system of claim 177, wherein the advertising system includes a couponing system.

179. The user information system of claim 177, wherein the advertising system includes information relating to businesses at the amusement park.

180. A user information system for a resort, comprising:
a communications network;
a server coupled to the communications network;
a terminal device including a processor and a display, the terminal device in communications with the communications network and configured to access information from the server; and
a user interface provided on the display of the terminal device, the user interface including user selectable options and configured to selectively provide user information to a resort user.

181. The user information system of claim 180, wherein the communications network is a resort communications network.

182. The user information system of claim 180, wherein the terminal device is a kiosk device.

183. The user information system of claim 180, wherein the terminal device is a handheld computer including a radio frequency transceiver.

184. The user information system of claim 180, wherein the communications network includes at least one RF transceiver coupled thereto and configured to provide communications with the handheld computer.

185. The user information system of claim 180, wherein the communications network includes a wireless communications network.

186. The user information system of claim 180, wherein the server includes an application service provider server.

187. The user information system of claim 180, wherein one of the user selectable options includes a navigator system.

188. The user information system of claim 187, wherein the navigator system is configured to provide maps to the user at the terminal device.

189. The user information system of claim 187, wherein the navigator system is configured to provide directions to the user.

190. The user information system of claim 187, wherein the navigator system is configured to identify destinations within the resort.

191. The user information system of claim 187, wherein the navigator system is configured to provide a three dimensional graphical representation of at least a portion of the resort.

192. The user information system of claim 187 wherein the navigator system is configured to provide directions to a requested destination.

193. The user information system of claim 192, wherein the navigator system is configured to provide advertising associated with the requested destination.

194. The user information system of claim 192, wherein the navigator system is configured to provide coupons associated with the requested destination.

195. The user information system of claim 180, wherein one of the user selectable options includes an explorer system.

196. The user information system of claim 195, wherein the explorer system is configured to provide maps, to destinations outside of the resort, to the user.

197. The user information system of claim 195, wherein the explorer system is configured to provide directions, to destinations outside of the resort, to the user.

198. The user information system of claim 195, wherein the explorer system is configured to identify destinations outside of the resort.

199. The user information system of claim 195, wherein the explorer system is configured to provide a three dimensional graphical representation of at least a portion of areas surrounding the resort.

200. The user information system of claim 195, wherein the explorer system is configured to provide directions to a requested destination.

201. The user information system of claim 200, wherein the explorer system is configured to provide advertising associated with the requested destination.

202. The user information system of claim 200, wherein the explorer system is configured to provide coupons associated with the requested destination.

203. The user information system of claim 195, wherein the explorer system is configured to provide resort services information.

204. The user information system of claim 195, wherein the explorer system is configured to provide a link to information relating to a requested destination.

205. The user information system of claim 195, wherein the explorer system includes access to a reservation system configured to enable reservations relating to a requested destination.

206. The user information system of claim 195, wherein the explorer system includes a navigation database link, the navigation database link configured to provide navigation and location information for locations outside of the resort.

207. The user information system of claim 180, wherein one of the user selectable options includes an activities system.

208. The user information system of claim 207, wherein the activities system is configured to provide resort information relating to activities and events at the resort.

209. The user information system of claim 207, wherein the activities system is configured to provide information relating to resort activities wait times.

210. The user information system of claim 207, wherein the activities system is configured to provide access to a resort reservation system.

211. The user information system of claim 180, wherein one of the user selectable options includes a resort reservation system.

212. The user information system of claim 211, wherein the reservation system provides options for resort dining reservations.

213. The user information system of claim 211, wherein the reservation system provides options for activities at the resort.

214. The user information system of claim 211, wherein the reservation system includes providing a ticket for a reserved event.

215. The user information system of claim 214, wherein the ticket is an electronic ticket comprising data stored on an electronic device.

216. The user information system of claim 180, wherein one of the user selectable options includes an excursion system.

217. The user information system of claim 180, wherein one of the user selectable options includes a resort user messaging system.

218. The user information system of claim 217, wherein the resort user messaging system provides text messaging between resort users at the resort.

219. The user information system of claim 217, wherein the resort user messaging system includes audio messaging between resort users at the resort.

220. The user information system of claim 217, wherein the resort messaging system includes video messaging between resort users at the resort.

221. The user information system of claim 217, wherein the resort messaging system includes an internet conduit configured for sending and receiving messages over the internet.

222. The user information system of claim 180, wherein one of the user selectable options includes a resort data system.

223. The user information system of claim 222, wherein the resort data system includes weather forecast information.

224. The user information system of claim 222, wherein the resort data system includes audio information.

225. The user information system of claim 222, wherein the resort data system includes graphical information.

226. The user information system of claim 180, wherein one of the user selectable options includes an account information system.

227. The user information system of claim 226, wherein the account information system includes resort transactions.

228. The user information system of claim 226, wherein the account information system includes an account status option.

229. The user information system of claim 226, wherein the account information system includes an option to create subaccounts.

230. The user information system of claim 180, wherein one of the user selectable options includes an emergency information system.

231. The user information system of claim 230, wherein the emergency information system includes an injured resort user reporting option.

232. The user information system of claim 230, wherein the emergency information system includes resort warning information.

233. The user information system of claim 180, wherein one of the user selectable options includes an advertising system.

234. The user information system of claim 233, wherein the advertising system includes a couponing system.

235. The user information system of claim 233, wherein the advertising system includes information relating to businesses at the resort.

236. The user information system of claim 233, wherein the advertising system includes information relating to resort businesses.

237. A method of providing site specific information to a user of a site, comprising:
providing a site user with a portable electronic device including wireless communications electronics;
accessing by the user a user interface with a plurality of user selectable information service options;
selecting an information service option;
communicating the selection from the portable electronic device to a site specific communications network; and
receiving a response to the selection by the portable electronic device from the site specific communications network.

238. The method of claim 237, further comprising:
charging a fee to the user for using the portable electronic device.

239. The method of claim 237, further comprising:
charging a fee to the user of the portable electronic device based on the amount of data accessed by the user.

240. The method of claim 237, further comprising:
charging advertising fees for providing advertisements to users of the portable electronic devices.
